(19) United States
(12) Patent Application Publication
(10) Pub. No.: US 2012/0098794 A1
(43) Pub. Date: Apr. 26, 2012

(54) Transmissive Body

(75) Inventors: Andrew Kleinert, Acton Austratian Capital Territory (AU); Duncan Ian Ross, Acton Austratian Capital Territory (AU); Jonathan Payne, San Jose, CA (US); Warwick Todd Holloway, Austratian Capital Territory (AU); Graham Roy Atkins, Austratian Capital Territory (AU); Robert Bruce Charters, Austratian Capital Territory (AU); Kenli Chong, Acton Austratian Capital Territory (AU); Dax Kukulj, Austratian Capital Territory (AU); Brigg Maund, Acton Austratian Capital Territory (AU); Ian Andrew Maxwell, New South Wales (AU)

(73) Assignee: RPO Pty Limited, Acton (AU)

(21) Appl. No.: 13/126,981

(22) PCT Filed: Oct. 30, 2009
(86) PCT No.: PCT/AU2009/001425

§ 371 Date: Dec. 13, 2011

(30) Foreign Application Priority Data
Oct. 31, 2008 (AU) 2008905605

(51) Int. Cl. G06F 3/042; G02B 27/42; G02B 27/30

(52) U.S. Cl. 345/175; 359/641; 359/558

(57) ABSTRACT

An apparatus and method for transmitting, collimating and redirecting light from a point-like source to produce a collimated optical signal in a substantially planar form are provided. In one embodiment the apparatus is manufactured as a unitary transmissive body comprising a collimation element and a redirection element, and optionally a transmissive element. In another embodiment the apparatus is assembled from one or more components. The apparatus and method are useful for providing sensing light for an optical touch input device.

### CROSS-REFERENCE TO RELATED APPLICATIONS

This application claims priority to Australian provisional application No. 2008905605 filed on 31 Oct. 2008, which is incorporated herein by reference.

This application is related to U.S. provisional patent application No. 60/917,567 filed May 11, 2007 and to U.S. provisional patent application No. 60/971,696 filed Sep. 12, 2007. This application is also related to Patent Co-Operation Treaty Patent Application No PCT/AU2008/000658 filed on May 12, 2008 and published as WO 08/138,049 A1. The contents of these applications are hereby incorporated herein by reference.

### FIELD OF THE INVENTION

In certain embodiments the present invention relates to input devices, and in particular, optical touch input devices. In other embodiments the present invention relates to apparatus for illuminating a display. In further embodiments the present invention relates to combined input devices and apparatus for illuminating a display. However it will be appreciated that the invention is not limited to these particular fields of use.

### BACKGROUND OF THE INVENTION

Any discussion of the prior art throughout the specification should in no way be considered as an admission that such prior art is widely known or forms part of the common general knowledge in the field.

Touch input devices or sensors for computers and other consumer electronics devices such as mobile phones, personal digital assistants (PDAs) and hand-held games are highly desirable due to their relative ease of use. In the past, a variety of approaches have been used to provide touch input devices. The most common approach uses a flexible resistive overlay, although the overlay is easily damaged, can cause glare problems, and tends to dim the underlying screen, requiring excess power usage to compensate for such dimming. Resistive devices can also be sensitive to humidity, and the cost of the resistive overlay scales quadratically with perimeter. Another approach is the capacitive touch screen, which also requires an overlay. In this case the overlay is generally more durable, but the glare and dimming problems remain.

In yet another common approach, a matrix of infrared light beams is established in front of a display, with a touch detected by the interruption of one or more of the beams. Such ‘infrared’ touch input devices have long been known (see U.S. Pat. Nos. 3,478,220 and 3,673,327), with the beams generated by arrays of optical sources such as light emitting diodes (LEDs) and detected by corresponding arrays of detectors (such as phototransistors). They have the advantage of being overlay-free and can function in a variety of ambient light conditions (U.S. Pat. No. 4,988,983), but have a significant cost problem in that they require a large number of source and detector components, as well as supporting electronics. Since the spatial resolution of such systems depends on the number of sources and detectors, this component cost increases with display size and resolution. Usually, the optical sources and detectors oppose each other across the display, although in some cases (disclosed for example in U.S. Pat. Nos. 4,517,559, 4,837,430 and 6,597,508) they are located on the same side of the display, with the return optical path provided by a reflector on the opposite side of the display.

An alternative infrared touch input technology, based on integrated optical waveguides, is disclosed in U.S. Pat. Nos. 6,351,260, 6,181,842 and 5,914,709. The basic principle of such a device is shown in FIG. 1. In this design, integrated optical waveguides 10 conduct light from an optical source 11 to integrated in-plane lenses 16 that collimate the light in the plane of a display and/or input area 13 and launch an array of light beams 12 across that display and/or input area 13. The light is collected by a second set of integrated in-plane lenses 16 and integrated optical waveguides 14 at the other side of the display and/or input area, and conducted to a position-sensitive (i.e. multi-element) detector 15. A touch event (e.g. by a finger or stylus) cuts one or more of the beams of light and is detected as a shadow, with position determined from the particular beam(s) blocked by the touching object. That is, the position of any physical blockage can be identified in each dimension, enabling user feedback to be entered into the device. Preferably, the device also includes external vertical collimating lenses (VCLs) 17 adjacent to the integrated in-plane lenses on each side of the input area, to collimate the light in the direction perpendicular to the plane of the input area.

As shown in FIG. 1, the touch input devices are usually two-dimensional and rectangular, with two arrays (X, Y) of ‘transmit’ waveguides 10 along adjacent sides of the input area, and two corresponding arrays of ‘receive’ waveguides 14 along the other two sides of the input area. As part of the transmit side, in one embodiment light from a single optical source 11 (such as an LED or a vertical cavity surface emitting laser (VCSEL)) is distributed to a plurality of transmit waveguides 10 forming the X and Y transmit arrays via some form of optical splitter 18, for example a 1×N tree splitter. The X and Y transmit waveguides are usually arranged on an L-shaped substrate 19, and the X and Y receive waveguides arranged on a similar L-shaped substrate, so that a single source and a single position-sensitive detector can be used to cover both X and Y dimensions. However in alternative embodiments, a separate source and/or detector may be used for each of the X and Y dimensions. Additionally, the waveguides may be protected from the environment by a bezel structure that is transparent at the wavelength of light used (at least in those portions through which the light beams 12 pass), and may incorporate additional lens features such as the abovementioned VCLs. Usually the sensing light is in the near IR, for example around 850 nm, in which case the bezel is preferably opaque to visible light.

For simplicity, only four pairs of transmit and receive waveguides per dimension are shown in FIG. 1. Generally there will be many more pairs per dimension, closely spaced so that the light beams 12 substantially cover the input area 13.

Compared to touch input devices with paired arrays of sources and detectors, waveguide-based devices have a significant cost advantage because of the greatly reduced number of optical sources and detectors required. Nevertheless, they still suffer from a number of drawbacks.

Firstly, because touch functionality is being increasingly common in consumer electronics devices such as mobile phones, handheld games and personal digital assistants (PDAs), there is a continuing requirement to reduce costs. Even if relatively inexpensive waveguide materials and fabrication techniques (such as curable polymers patterned by a photolithographic or moulding process) are used, the transmit and receive waveguide arrays still represent a significant fraction of the cost of the touch input device. Secondly there is a signal-to-noise problem: because the transmit waveguides are small (typically they have a square or rectangular cross section with sides of order 10 μm), it is difficult to couple a large amount of ‘signal’ light into them from the optical source. Since only a fraction of this light will be captured by the receive waveguides, the system as a whole is vulnerable to ‘noise’ from ambient light, especially if used in bright sunlight. Thirdly, because the device uses discrete beams 12, the transmit and receive waveguides need to be carefully aligned during assembly. A similar alignment requirement applies to the older infrared touch input devices with arrays of discrete sources and detectors.

Inspection of the waveguide-based touch input device shown in FIG. 1 reveals that positional information for a touching object is encoded on the receive waveguides 14; that is to say, the position of the object is determined from those particular receive waveguides that receive less or no light and convey that condition to the respective elements of the multi-element detector 15. The transmit side is less critical, and two sheets of light propagating in the X and Y directions can be used in place of the grid of discrete beams 12.

An alternative configuration disclosed in U.S. Pat. No. 7,099,553 and shown schematically in FIG. 2 provides a sheet of light, while still using a minimal number of optical sources, by replacing the transmit waveguides with a single ‘bulk optics’ waveguide in the form of a light pipe 21 with a plurality of reflective facets 22. In operation, light from an optical source 11 is launched into an input face of the light pipe 21, optionally with the assistance of a lens 23, and this light is deflected by the reflective facets 22 to produce sheets of light 45 that traverse the input area 13 towards the receive waveguides 14. As shown in FIG. 2, the light pipe 21 is an L-shaped item encompassing both ‘transmit sides’ of the input area 13, with a turning mirror 24 at its apex. In a minor variation there may be separate, substantially linear light pipes for each of the transmit sides. Advantageously, the light pipe 21 may comprise a polymer material formed by injection moulding for example, and as such will be considerably less expensive to fabricate than an array of waveguides. It will be further appreciated that since the light pipe 21 is a ‘bulk optics’ component, it will be relatively straightforward to couple light into it with high efficiency from an optical source 11, thereby improving the signal-to-noise ratio.

As mentioned in U.S. Pat. No. 7,099,553, the output faces 25 of the light pipe 21 can be shaped with cylindrical curvature to form lenses 26 that collimate the light sheets 45 in the vertical (i.e. out-of-plane) direction, obviating the need for any separate vertical collimating lens. This will further reduce the Bill of Materials, and possibly also the assembly costs.

Light pipes with a plurality of reflective facets are commonly used for distributing light from a single light source for illumination purposes (see for example U.S. Pat. No. 4,068,121). Two-dimensional versions such as a substantially planar light guide plate with a plurality of reflective facets on one surface are also known for display backlighting, as disclosed in U.S. Pat. No. 5,050,946 for example. In most known light pipes and light guide plates, the reflective facets are formed along an exterior edge or surface. The light pipe 21 disclosed in U.S. Pat. No. 7,099,553 has a rather different form, where the facets 22 are essentially internal to the light pipe body, and are stepped in height so that each facet only reflects a small fraction of the light guided within the light pipe. An advantage with this design is that the width 27 of the light pipe is relatively small, which is important for touch input devices where the ‘bezel width’ around a display should not be excessive. However it has the significant disadvantage of being a complicated design, with numerous sharp corners and concave portions that will be extremely difficult to reproduce accurately via injection moulding. A second problem is that, analogous to the well-known principle of single slit diffraction, the divergence angle of a light beam reflected off a facet will depend on the height of that facet. Therefore the incremental height of the facets 22 in the light pipe 21 will cause the reflected beams to have incrementally varying divergence in the out-of-plane direction, such that a simple cylindrical lens 26 will not be able to completely collimate the light sheets 45.

A much simpler infrared touch input device where a minimal number of optical sources are used to generate a sheet of sensing light is disclosed in U.S. Pat. No. 4,986,662. As illustrated in FIG. 2A, a touch input device includes a rectangular frame 91 with an optical source 11 and an array of detectors 56 along two sides and parabolic reflectors 92 on the opposing two sides. Light 35 emitted from each optical source propagates across the input area 13 towards a respective parabolic reflector, and is reflected back across the input area as sheets of light 45 in the X and Y dimensions. Unfortunately this simple configuration has the disadvantage that in many parts of the input area, a touch object 60 will block the outgoing light 35, complicating the detection algorithms.

Another class of touch input device that relies on the interruption of light paths, commonly known as an ‘optical’ touch input device and described in U.S. Pat. Nos. 4,507,557, 6,943,779 and 7,015,894 for example, is illustrated schematically in FIG. 2B. An optical touch input device 200 typically includes a pair of optical units 202 in adjacent corners of a rectangular input area 13 and a retro-reflective layer 204 along three edges of the input area. Each optical unit includes a light source emitting a fan of light 206 across the input area, and a photo-detector array (e.g. a line camera) where each detector pixel receives light retro-reflected from a certain portion of the retro-reflective layer. A touch object 60 in the input area prevents retro-reflected light reaching one or more detector pixels in each photo-detector array, and its position is determined by triangulation. A known problem with this form of device is relatively poor spatial resolution in the portion of the input area close to the edge 208 between the two optical units. Hybrid infrared/optical touch input devices where arrays of optical fibres around the edges of a rectangular input area receive light from optical sources in the corners are also known, see for example PCT Patent Application Publication No WO 2008/130145 A1, but these can likewise suffer from relatively poor spatial resolution close to one or more of the edges.

It is an object of the present invention to overcome or ameliorate at least one of the disadvantages of the prior art, or to provide a useful alternative.

### SUMMARY OF THE INVENTION

According to a first aspect the present invention provides a transmissive body for an input device, said body comprising:
a collimation element adapted to substantially collimate an optical signal; and
a redirection element adapted to substantially redirect an optical signal,
wherein said elements are arranged to receive a substantially planar optical signal and collimate and redirect said optical signal to produce a substantially collimated planar signal.

Preferably the elements are arranged to receive a substantially planar optical signal and collimate, redirect and transmit said optical signal to produce a substantially collimated planar signal. Preferably the elements are arranged to receive a substantially planar optical signal propagating in a first plane and redirect the optical signal as a substantially collimated planar signal into a second plane different from the first plane. In one embodiment the first and second planes are substantially parallel. In another embodiment the substantially collimated planar signal is redirected into one or more planes substantially parallel to and spaced from the first plane. In yet further embodiments the substantially collimated planar signal is redirected toward the source of the substantially planar optical signal.

In preferred embodiments according to the first aspect the transmissive body is formed from a unitary piece of plastics material substantially transparent to light of the infrared or visible region of the spectrum and optionally opaque to ambient visible light.

In one embodiment the transmissive body according to the first aspect may receive an optical signal in a substantially planar form. In another embodiment the transmissive body according to the first aspect may receive light from a plurality of light sources, such as an array of LEDs. In yet a further embodiment the transmissive body according to the first aspect may receive light from a cold cathode fluorescent lamp (CCFL).

According to a second aspect the present invention provides a transmissive body for an input device, said body comprising:
(a) a transmissive element adapted to receive, confine and transmit an optical signal in planar form; and
(b) a collimation and redirection element adapted to substantially collimate and redirect an optical signal;
   wherein said elements are arranged to receive an optical signal from an optical source and transmit, collimate and redirect said optical signal to produce a substantially collimated signal in a substantially planar form.

According to a third aspect the present invention provides a transmissive body for an input device, said body comprising:
(a) a transmissive element adapted to receive, confine and transmit an optical signal in planar form;
(b) a collimation element adapted to substantially collimate an optical signal; and
(c) a redirection element adapted to redirect an optical signal,
wherein said elements are arranged to receive an optical signal from an optical source and transmit, collimate and redirect said optical signal to produce a substantially collimated signal in a substantially planar form.

Preferably the transmissive element is substantially planar, such as in the form of a slab. However it will be appreciated that the transmissive element may be in any form provided that: 1.) the transmissive element is adapted to receive an optical signal from an optical source, 2.) the transmissive element is adapted to transmit the signal in planar form, and 3.) the transmissive element confines the optical signal within its outer periphery. In one preferred embodiment the optical source is a point source of diverging light (as discussed further below), optically coupled to a substantially planar transmissive element, such that the light is confined in the narrow dimension of the transmissive element but diverges freely in the broad dimension of the transmissive element. The collimation element and/or the redirection element span the full width of the transmissive element along a side opposing the optical source, and ideally the light will diverge sufficiently within the transmissive element so as to ‘fill’ this opposing side. If necessary a lens can be inserted to ensure that this occurs.

In one embodiment the transmitted substantially collimated planar signal is redirected in a plane substantially coplanar with the transmissive element if present or the received substantially planar optical signal. For example the collimated planar signal may be redirected to one side of the transmissive body. However, in alternative embodiments the substantially collimated planar signal is redirected into one or more planes substantially parallel to and spaced from the transmissive element. In this embodiment the collimated planar signal may be directed back towards the optical source or away from the optical source. Whilst it is preferable to redirect the entire substantially collimated planar signal, further embodiments are contemplated in which only a portion (or portions) of the substantially collimated planar signal are redirected. In a preferred embodiment the substantially collimated planar signal is redirected into free space. In an alternative embodiment the substantially collimated planar signal is redirected into a planar waveguide. If the substantially collimated planar signal is redirected in a plane substantially parallel to the transmissive element, this planar waveguide can be integrated with the transmissive element.

In preferred embodiments the collimation element and/or the redirection element are/is in the form of a mirror or a lens. However, the collimation element and/or the redirection element may be a plurality of collimation elements and redirection elements adapted to produce a plurality of substantially collimated signals in planar form from a single optical source.

Preferably the optical source is a point source emitting a diverging optical signal, for example an LED. In this case the collimation element is preferably a substantially parabolic reflector or a substantially elliptical lens, shaped and positioned such that its focus is substantially coincident with the optical source. The skilled person will appreciate that the aforementioned configuration enables the transmissive body of the invention to provide collimation of a diverging optical signal into substantially parallel rays of light, i.e. collimation of the optical signal.

The transmissive body may be formed as either a unitary body or a plurality of bodies, depending on the embodiment. For example, for embodiments according to the first aspect, the transmissive body may be a unitary body or a pair of bodies. For embodiments according to the second or third aspects, the transmissive body may be:
1.) a unitary body comprising all three of the collimation, redirection and transmissive elements,
2.) a pair of bodies wherein one of the bodies comprises any two of the collimation, redirection and transmissive elements and the other of the bodies comprises the remaining element, or
3.) a triad of bodies, wherein each body comprises only one of the collimation, redirection and transmissive elements.

In preferred embodiments the collimation element and the redirection element are both optically downstream of the transmissive element. However, it will be appreciated that one or both of the collimation element and the redirection element may be optically upstream of the transmissive element. However, as the skilled person will be aware the relative positioning and pointing accuracy of the optical source in this latter embodiment requires significantly greater precision to ensure that a sufficient quantity of the optical signal is transmitted and that the optical signal is sufficiently collimated.

In a first construction, a single optical source is provided which is optically coupled to a transmissive body according to the first aspect. It will be appreciated that the transmissive body provides a single sheet or lamina of substantially collimated planar optical signal. This substantially collimated planar signal may then be directed into one or more light detecting elements for detecting an input; the input being determined by an interruption of the collimated planar signal.

In a further construction a pair of optical sources may be included and oriented substantially perpendicularly to each other on adjacent sides of a transmissive element. Pairs of collimation and redirection elements may also be provided on mutually opposing sides of the transmissive element to each of the optical sources, thereby providing a pair of substantially collimated planar signals that propagate in substantially perpendicular directions. In one embodiment the collimated planar signals are coplanar, however the collimated planar signals may be in mutually spaced apart parallel planes.

In yet a further construction, a single optical source is optically coupled to the transmissive element, with pairs of collimation and redirection elements provided and positioned to produce a pair of substantially collimated planar signals that, in one arrangement, propagate in substantially perpendicular directions. Again, such collimated planar signals may be coplanar or in mutually spaced apart parallel planes.

It will be appreciated that a display may be positioned between the substantially collimated planar signal and the transmissive element or, in the case where the transmissive element is transparent, a display may be positioned on the opposite side of the transmissive element to the substantially collimated planar signal. In this latter embodiment the transmissive element itself forms the touch surface.

In yet a further construction, a single optical source is optically coupled to a transmissive element, and the collimation and redirection elements redirect the light into a planar waveguide provided on a surface of the transmissive element. In this embodiment the planar waveguide forms the touch surface, and input is determined by a reduction in the amount of light guided in the planar waveguide.

According to a fourth aspect the present invention provides a signal production device for an input device, comprising:
an optical source for providing an optical signal; and
a transmissive body comprising:
(a) a transmissive element adapted to receive, confine and transmit said optical signal in planar form;
(b) a collimation element adapted to substantially collimate said optical signal; and
(c) a redirection element adapted to redirect said optical signal, wherein said elements are arranged to receive said optical signal and transmit, collimate and redirect said optical signal to produce a substantially collimated signal in a substantially planar form.

According to a fifth aspect the present invention provides an input device, comprising:
an optical source for providing an optical signal; and
(a) a transmissive element adapted to receive, confine and transmit an optical signal in planar form;
(b) a collimation element adapted to substantially collimate an optical signal; and
(c) a redirection element adapted to redirect an optical signal,
wherein said elements are arranged to receive said optical signal and transmit, collimate and redirect said optical signal to produce a substantially collimated signal in a substantially planar form, said substantially collimated planar signal being directed to at least one light detecting element for detecting an input.

The light detecting element is adapted to receive at least a portion of the substantially collimated planar signal for detecting an input. The light detecting element preferably comprises at least one optical waveguide in optical communication with at least one detector.

In preferred embodiments the transmissive body is formed from a unitary piece of plastics material substantially transparent to the signal light. Preferably this signal light is in the infrared region of the spectrum, in which case the plastics material may optionally be opaque to ambient visible light. In these embodiments the transmissive body is preferably injection moulded. However, it will be appreciated that the transmissive body, or even portions of the transmissive body such as the transmissive element, the collimation element and/or the redirection element could be fabricated from other materials such as glass, and optically joined together. In one particularly preferred embodiment, the transmissive element is composed of glass and the collimation and redirection elements are together composed of a unitary piece of injection moulded plastics material.

According to a sixth aspect the present invention provides a method for producing an optical signal in substantially collimated planar form, said method comprising the steps of:

providing an optical signal from an optical source;

receiving, confining and transmitting an optical signal in planar form;

substantially collimating an optical signal; and

redirecting an optical signal.

Preferably a substantially planar transmissive element confines and transmits the optical signal in a planar form, a collimation element collimates the optical signal in planar form, and a redirection element redirects the substantially collimated planar signal. In this aspect, the transmissive element, collimation element and redirection element define the transmissive body.

Preferably the method according to the sixth aspect further comprises the step of redirecting the substantially collimated planar signal into a plane substantially parallel to the transmissive element. The method preferably further comprises the step of redirecting the substantially collimated planar signal into one or more planes substantially parallel to and spaced from the transmissive element. In one embodiment the method comprises the step of redirecting the substantially collimated planar signal back towards the optical source, which is a point source providing a diverging optical signal. The collimation element may include one or more substantially parabolic reflectors or one or more substantially elliptical lenses, and wherein each of the one or more substantially parabolic reflectors or elliptical lenses is shaped and positioned such that its focus is substantially coincident with the point source.

In another embodiment, the method comprises the step of providing a pair of optical sources and corresponding pairs of collimation elements and redirection elements for providing a pair of substantially collimated planar signals propagating in substantially perpendicular directions.

In another embodiment, the method further comprises the step of providing a single optical source and pairs of collimation elements and redirection elements for providing a pair of substantially collimated planar signals propagating in substantially perpendicular directions.

According to a seventh aspect the present invention provides a method for producing an optical signal in substantially collimated planar form, the method comprising the steps of:
(a) providing an optical signal from an optical source; and
(b) optically coupling the optical source into a transmissive body according to the first, second or third aspects.

The present invention provides significant advantages over the prior art. For example, one significant issue with prior art devices relates to the need to align the transmitters with the receivers in the plane of the input area, whether the transmitters and receivers are discrete optical components as in U.S. Pat. No. 3,478,220 or waveguides as in U.S. Pat. No. 5,914,709. In contrast, since the transmit signal of the instant invention is a sheet/lamina of substantially collimated light, preferably in free space but alternatively guided within a planar waveguide, there is now no requirement to align receivers with transmitters in this plane. Each receiver simply receives a portion of light being directed at it and any of its neighbours, and registers interruption of the sheet of light as an input.

As discussed in the foregoing, the various elements of the transmissive body according to the present invention are arranged to receive an optical signal from an optical source and transmit, collimate and redirect the optical signal to produce a substantially collimated signal in a substantially planar form. The optical source is preferably a ‘point’ light source, such as a LED. However, in other embodiments the optical source may be a plurality of light sources, such as an array of LEDs, or even light from a cold cathode fluorescent lamp (CCFL). In preferred embodiments where a single LED is used as the optical source, the collimation element of the transmissive body is preferably a substantially parabolic reflector or a substantially elliptical lens, shaped and positioned such that its focus is substantially coincident with the LED point light source.

It will be appreciated that the degree of collimation of the transmitted light is dependent, in part, upon positioning the LED point light source at the focus of the substantially parabolic reflector/elliptical lens collimation element. Further, it will be appreciated that if the LED point light source is ‘incorrectly’ positioned on either side of the focus of the substantially parabolic reflector/elliptical lens then the collimated light will not be parallel to the ‘focal axis’ of the reflector or lens, defined for a parabola as the line perpendicular to the directrix and passing through the focus, and defined for an ellipse as the line passing through both foci. The consequence of the incorrect positioning is that optical element(s) intended to receive the emitted substantially collimated substantially planar signal, such as an array of waveguides, will not be correctly aligned. These light source positioning problems can be overcome to some extent by using an LED with a larger illumination area. However, this introduces further problems, for example the efficiency is reduced because not of all of the light being generated is being effectively used, and the presence of out-of-focus light can create blurring of the light received by the collimation element.

To avoid the necessity of having to carefully position a single LED point light source, a small array of individually controllable LEDs may be used and the apparatus configured to activate only the best-located LED to achieve optimal collimated light, which is preferably parallel to the focal axis (or simply the ‘axis’) of the collimation element. During the production phase of an apparatus comprising the transmissive body of the invention, a computer algorithm can be used to test for which of the individual LEDs or combination of LEDs gives the best system performance. This will generally correspond to the LED that is at the focus (or focal point), or combination of LEDs that cover the focal point. The additional cost of including a small LED array as opposed to a single LED point light source is offset by the flexibility such a configuration provides. Of course, it will be appreciated that precise positioning of a point source of light is less important when the transmissive body of the invention is being utilised to direct light into an assembly for illuminating a display, as described in WO 08/138,049 A1.

According to an eighth aspect the present invention provides a method for producing an optical signal in substantially collimated substantially planar form, said method comprising the steps of:

(a) providing a plurality of optical signals from a plurality of individually controllable optical sources;
(b) receiving, confining and transmitting said plurality of optical signals in a substantially planar form;
(c) substantially collimating said plurality of optical signals;
(d) redirecting said plurality of said optical signals; and
(e) receiving said plurality of optical signals in at least one light detecting element;
wherein one or more of said plurality of optical sources are independently activated to obtain a substantially collimated substantially planar signal with optimum characteristics.

Preferably the ‘characteristics’ of the resulting substantially collimated substantially planar signal include intensity and the degree of collimation of the optical signal. Preferably the ‘optimum’ substantially collimated substantially planar signal is the signal that is most parallel to the focal axis of the collimation element, which may correspond to one or more of the individually controllable optical sources.

Preferably a controller is utilised to activate each of the plurality of controllable optical sources individually and to determine the resulting substantially collimated substantially planar signal corresponding to each optical source, and then utilise only the optical source, or optical sources, which provide the optimum substantially collimated substantially planar signal. It will be appreciated that this feature can be programmed into the start-up mode of the device comprising the apparatus of the invention.

Preferably the plurality of optical sources are provided as an array. The method preferably includes the step of determining the characteristics of the resulting substantially collimated substantially planar signal by analysing the output of the at least one light detecting element. Preferably the method includes the step of activating that single optical source which corresponds to the resulting substantially collimated substantially planar signal which is most parallel to the focal axis of the collimation element. Alternatively, the method includes the step of activating two or more optical sources which cover the focal point and which produce a substantially collimated substantially planar signal which is most parallel to the focal axis of the collimation element.

According to a ninth aspect the present invention provides a signal production device for an input device, said signal production device comprising:

(a) a plurality of individually controllable optical sources for providing a plurality of optical signals; and
(b) a transmissive body comprising:
(i) a transmissive element adapted to receive, confine and transmit said optical signals in planar form;
(ii) a collimation element adapted to substantially collimate said optical signals; and
(iii) a redirection element adapted to redirect said optical signals,
wherein said elements are arranged to receive an optical signal and transmit, collimate and redirect said optical signal to produce a substantially collimated signal in a substantially planar form; and
(c) at least one light detecting element for receiving said optical signal from said transmissive body,
wherein one or more of said plurality of controllable optical sources may be independently activated to produce a substantially collimated substantially planar signal with optimum characteristics.

Preferably each of said plurality of controllable optical sources are individually activated and the characteristics of the resulting substantially collimated substantially planar signal corresponding to each optical source are determined by said at least one light detecting element, wherein, in use, only the optical source or optical sources which provide the optimum substantially collimated substantially planar signal are utilised.

In the embodiments discussed in the foregoing, a point source of light has been used to deliver an optical signal to the transmissive body of the invention to produce a substantially collimated signal in a substantially planar form. In these embodiments the point source of light has been preferably positioned at the focus of the collimation element. However, in an alternative embodiment, the point source of light may be deliberately positioned ‘off axis’. In one example of this embodiment the point source of light may be positioned at a corner of the transmissive element (and facing the collimation element). In this example, the light emitted by the transmissive body remains substantially collimated, however is emitted at an angle to the focal axis of the collimation element. However, it will be appreciated that a mirror can be utilised to reflect the light emitted off-axis back across the transmissive element. In a variation of this embodiment, a pair of point sources of light can be used, for example at two corners of the transmissive element (again facing the collimation element). In this embodiment, two substantially planar sheets of substantially collimated light will be produced, both of which propagate in off-axis directions. Again, pairs of mirrors can be positioned to reflect the off-axis sheets of collimated light back across the transmissive element.

The advantage of this latter embodiment is that a single collimation element can be used to generate a pair of sheets of collimated light that propagate at an angle relative to each other. Preferably the sheets of light are in the same plane (i.e. coplanar) or in closely spaced parallel planes. As discussed above, mirrors can be used to reflect the off-axis light back towards appropriately positioned/angled detectors, or appropriately positioned/angled waveguides to receive and collect light. In this way, it is possible to determine a touch location in two dimensions since there are two intersecting sheets of light. Besides the advantage of only requiring a single collimation element, this embodiment also offers significantly reduced bezel width on the sides having the mirrors. Further advantages will be apparent in a reduction in system complexity and cost. It will be appreciated that when this embodiment is used in an input device the mirrors will have to be placed parallel to the sides of the input area and the receive waveguides will need to be angled appropriately to receive light from a respective sheet of light produced by the transmissive body according to this embodiment of the invention.

In the foregoing embodiments, wherein the source of light is positioned off-axis, it will be appreciated that the emitted planar sheet of light will not be perfectly collimated. However this ‘incomplete collimation’ of light is a relatively small effect, and it has been found that the individual rays of light still have sufficient collimation such that the sheet of light is substantially collimated so as be useful in the foregoing methods of the invention. Alternatively, the skilled person would appreciate that it would be possible to accommodate for this effect by appropriately angling the receive waveguides.

In further embodiments, it is possible to include three point sources of light, for example one positioned at the focus of the collimation element and the other two at two corners of the transmissive element. In this way three sheets of light are generated, each propagating in a different direction. The skilled person will appreciate that this embodiment provides an efficient means for resolving the so-called double touch ambiguity often encountered in infrared touch input devices.

According to a tenth aspect the present invention provides a signal production device for an input device, said signal production device comprising:

an optical source for providing an optical signal; and
a transmissive body comprising:
(a) a transmissive element adapted to receive, confine and transmit said optical signal in planar form;
(b) a collimation element adapted to substantially collimate said optical signal, said collimation element having a focal point on a focal axis; and
(c) a redirection element adapted to redirect said optical signal,
wherein said elements are arranged to receive said optical signal and transmit, collimate and redirect said optical signal to produce a substantially collimated signal in a substantially planar form,
wherein said optical source is positioned to one side of said focal axis thereby to cause said substantially collimated substantially planar signal to propagate at an angle to said focal axis.

Preferably the signal production device further includes one or more mirrors positioned adjacent said transmissive element to redirect said substantially collimated substantially planar signal back across said transmissive element. Preferably the substantially collimated substantially planar signal propagates at angles to the focal axis between about 5 and 40°.

According to an eleventh aspect the present invention provides a method for producing an optical signal in substantially collimated substantially planar form, said method comprising the steps of:

(a) providing an optical signal from an optical source;
(b) receiving, confining and transmitting said optical signal in substantially planar form with a transmissive element;
(c) substantially collimating said optical signal with a collimation element, said collimation element having a focal point on a focal axis; and
(d) redirecting said substantially collimated optical signal,
wherein said optical source is positioned to one side of said focal axis such that the resulting substantially collimated substantially planar signal propagates at an angle to said focal axis.

Preferably a pair of optical sources are utilised to produce a corresponding pair of optical signals. Preferably the resulting pair of substantially collimated substantially planar signals are coplanar or in closely spaced parallel planes.

Preferably three optical sources are utilised to produce a corresponding triad of optical signals, wherein one of said optical sources is positioned at the focal point of said collimation element and the other two optical sources are positioned on either side of the focal point.

Preferably the optical source is a first optical source positioned with respect to the transmissive body so as to produce a first substantially collimated substantially planar signal propagating at a first angle to the focal axis. The first optical source is preferably a point source, more preferably a LED. Preferably the first optical source is positioned adjacent a corner of the transmissive element and faces the collimation element. Preferably the method further the step of reflecting the first substantially collimated substantially planar signal back across the transmissive element. The first angle is preferably between about 5 and 40°.

Preferably the method further includes the provision of a second optical source positioned with respect to the transmissive body so as to produce a second substantially collimated substantially planar signal propagating at a second angle to the focal axis, different to the first angle.

Preferably the second optical source is in the form of a point source, more preferably a LED. The second optical source is preferably positioned on the other side of the focal axis to the first optical source. Preferably the second optical source is positioned adjacent a second corner of the transmissive element and faces the collimation element.

Preferably the method further includes the step of reflecting the second substantially collimated substantially planar signal back across the transmissive element. The second angle is preferably between about 5 and 40°.

Preferably the first and the second substantially collimated substantially planar signals are coplanar or in closely spaced parallel planes. The method preferably further includes the step of receiving the first substantially collimated substantially planar signal in at least one first light detecting element, and receiving the second substantially collimated substantially planar signal in at least one second light detecting element. Preferably the at least one first light detecting element and the at least one second light detecting element are each arrays of waveguides which are angled to receive light from a corresponding substantially collimated substantially planar signal.

Preferably the method further includes the provision of a third optical source positioned with respect to the transmissive body so as to produce a third substantially collimated substantially planar signal propagating at a third angle to the focal axis, different to the first angle and the second angle. The third optical source is preferably in the form of a point source, more preferably a LED. Preferably the third optical source is positioned substantially at the focal point and facing the collimation element such that the third angle is approximately zero.

Preferably the first, the second and the third substantially collimated substantially planar signals are coplanar or in closely spaced parallel planes. The method preferably further includes the step of receiving the third substantially collimated substantially planar signal in at least one third light detecting element. Preferably the at least one third light detecting element is an array of waveguides which are angled to receive light from the third substantially collimated substantially planar signal.

According to a twelfth aspect the present invention provides a method for resolving double touch ambiguity in an input area, said method comprising the steps of:

(a) providing at least three optical signals from at least three optical sources;
(b) receiving, confining and transmitting said optical signals in substantially planar form;
(c) substantially collimating said optical signals with a collimation element, said collimation element having a focal point on a focal axis; and
(d) redirecting said optical signals,
wherein a first of said optical sources is positioned substantially at said focal point to produce a first substantially collimated substantially planar signal propagating substantially parallel to said focal axis, and
wherein the second and third optical sources are each positioned apart or spaced from said focal point, to produce respectively second and third substantially collimated substantially planar signals each propagating at an angle to said focal axis, such that said first, second and third substantially collimated substantially planar signals may be respectively received in corresponding light detecting elements for resolving said double touch ambiguity.

Preferably the second and third optical sources are positioned on opposite sides of said focal axis.

As discussed in the foregoing, certain embodiments of the transmissive body of the invention include a collimation element adapted to substantially collimate an optical signal, and a redirection element adapted to substantially redirect an optical signal. It will be appreciated that the elements are arranged to receive a substantially planar optical signal and collimate and redirect the optical signal to produce a substantially collimated planar signal. The collimation element and the redirection element may be formed as a unitary body comprising separate collimation and redirection elements or a combined collimation and redirection element, or as a pair of bodies wherein one of said bodies is a collimation element and the other a redirection element. The former embodiment (a unitary body) has been described above, and in the following a transmissive body comprising separate collimation and redirection elements is described.

In one embodiment, the collimation element and the redirection element are positioned on opposite sides of a transmissive element. To explain, the transmissive element is preferably a slab-like element, and an in-plane parabolic reflector (collimation element) is positioned on one side of the transmissive element and a straight retro-reflector (redirection element) is positioned on the other side of the transmissive element. Preferably the retro-reflector is an elongated 45° prism. Light from a point source is introduced into the arrangement from beneath the retro-reflector, propagates through the transmissive element, is collimated by the parabolic reflector and reflected back through the transmissive element to the retro-reflector which redirects the collimated light into a plane above and parallel to the transmissive element. In this embodiment, the ‘in-plane parabolic reflector’ does not necessarily need to extend the full width of the transmissive element, although the width of the parabolic reflector will determine the width of the final collimated signal. Further, the parabolic reflective surface may need to be metallised if the total internal reflection (TIR) condition cannot be satisfied, as the skilled person will readily appreciate.

According to a thirteenth aspect the present invention provides a transmissive body, comprising:

(a) a transmissive element adapted to receive, confine and transmit an optical signal in planar form;
(b) a collimation element adapted to substantially collimate said planar optical signal; and
(c) a redirection element adapted to redirect said substantially collimated planar optical signal,
wherein said collimation element and said redirection element are positioned on opposite sides of said transmissive element, and said elements are arranged to receive an optical signal from an optical source and transmit, collimate and redirect said optical signal to produce a substantially collimated signal in substantially planar form.

Preferably the optical signal is directed through the redirection element and into the transmissive element. The transmissive element, the collimation element and the redirection element are preferably separate bodies. Preferably the redirection element is an elongated 45° prism.

Preferably the collimation element is adapted to reflect light back into the transmissive element. The substantially collimated substantially planar signal preferably propagates parallel to the transmissive element. Preferably the width of the collimation element is less than the width of the transmissive element. The collimation element is preferably a metallised reflector in the form of a parabola or a segmented parabola.

In another embodiment, wherein the collimation element and redirection element form a unitary body positioned to receive light from a transmissive element, the redirection element includes an angled output facet. This embodiment takes advantage of the fact that a ‘bulk optics’ transmissive element is sufficiently thick to support a large number of optical modes, equivalent in the ray optics picture to guiding light rays bouncing along over a range of angles. It has been found that in some cases a proportion of light propagating in a transmissive element can be divergent, rather than propagating in a substantially coplanar way, i.e. off-axis rays of light. In such cases, the off-axis rays of light cause the emitted light to be somewhat divergent. It has been found that including an angled output facet can substantially realign the collimated light ‘back down’ into the plane of the input area. Preferably the angled output facet is a refractive element, but in an alternative embodiment it can be a reflective element. In one specific embodiment the output facet is a refractive element with optimum angle about 50° from the vertical. However, it will be appreciated that other angles will also fall within the purview of the present invention. Further, it has surprisingly been found that the use of an angled output facet provides an optical throughput 40% higher than for an alternative transmissive body not requiring an angled output facet. A further advantage of the angled output facet is that the output facet provides an angled bezel, which is preferred to a vertical bezel both aesthetically and to prevent dirt build up. It will be appreciated that an angled output facet is applicable to other embodiments described herein.

According to a fourteenth aspect the present invention provides a transmissive body for an input device, said body comprising:

(a) a transmissive element adapted to receive, confine and transmit an optical signal in substantially planar form; and
(b) a collimation and redirection element adapted to substantially collimate and redirect said substantially planar optical signal, said collimation and redirection element including an angled output facet;
wherein said elements are arranged to receive an optical signal from an optical source and transmit, collimate and redirect said optical signal to produce a substantially collimated signal in a substantially planar form propagating across the plane of an input area of said input device.

Preferably the collimation and redirection element includes a reflector in the form of a parabola or a segmented parabola. The angled output facet is preferably a refractive surface. Preferably the output facet is angled between 10 and 60° from the vertical, more preferably at 50° from the vertical. The collimation and redirection element is preferably about twice the height of the transmissive element. Preferably the collimation and redirection element is a unitary body.

According to a fifteenth aspect the present invention provides a transmissive body comprising:

(a) a transmissive element adapted to receive, confine and transmit an optical signal in substantially planar form, wherein said transmissive element defines a plane; and
(b) a collimation and redirection element adapted to substantially collimate and redirect an optical signal;
wherein said elements are arranged to receive an optical signal from an optical source and transmit, collimate and redirect said optical signal to produce a substantially collimated signal in a substantially planar form,
wherein said collimation and redirection element is configured to direct said substantially planar optical signal substantially perpendicular to said plane of said transmissive element, collimate said substantially planar optical signal and redirect said substantially collimated substantially planar optical signal.

Preferably the substantially collimated substantially planar optical signal propagates substantially parallel to said plane.

As discussed in the foregoing, the collimation element is preferably a substantially parabolic reflector or a substantially elliptical lens. However, it will be appreciated that a collimation element in the form of a parabolic reflector or a substantially elliptical lens can be substituted with a segmented reflector (as described in WO 08/138,049 A1) or a segmented lens (such as a Fresnel lens), see FIG. 17. The advantage of a segmented reflector or lens is that it provides a collimation element with reduced width compared to a collimation element in the form of a parabolic reflector or an elliptical lens, which provides reductions in bezel width when used in an input device. Other variations of segmented lenses or reflectors are known to those skilled in the art, for example diffractive gratings.

According to a sixteenth aspect the present invention provides a transmissive body comprising:

(a) a transmissive element adapted to receive, confine and transmit an optical signal in substantially planar form;
(b) a collimation element adapted to substantially collimate an optical signal; and
(c) a redirection element adapted to redirect an optical signal,
wherein said elements are arranged to receive an optical signal from an optical source and transmit, collimate and redirect said optical signal to produce a substantially collimated signal in a substantially planar form,
wherein said collimation element is a segmented reflector, a segmented lens or a diffractive grating.

Preferably the segmented lens is a Fresnel lens. Preferably the transmissive body is formed as either:

a.) a unitary body comprising all three of said collimation, redirection and transmissive elements,
b.) a pair of bodies wherein one of said bodies comprises any two of said collimation, redirection and transmissive elements and the other of said bodies comprises the remaining element, or
c.) a triad of bodies, each said body comprising one of said collimation, redirection and transmissive elements.

In certain preferred embodiments the redirection element comprises one or more metallised plane reflectors. Preferably, the transmissive element is planar and the redirection element comprises a pair of metallised plane reflectors oriented at 45° to the plane of the transmissive element such that the substantially collimated, substantially planar signal propagates substantially parallel to the transmissive element.

In alternative embodiments the transmissive element is omitted, and the collimation element and redirection element configured to receive a substantially planar optical signal and collimate and redirect the optical signal to produce a substantially collimated planar signal.

According to a seventeenth aspect the present invention provides a transmissive body comprising:
(a) a collimation element adapted to substantially collimate an optical signal; and
(b) a redirection element adapted to redirect an optical signal,
wherein said elements are arranged to receive a substantially planar optical signal and collimate and redirect said optical signal to produce a substantially collimated signal,

wherein said collimation element is a segmented reflector, a segmented lens or a diffractive grating.

It will be appreciated by the skilled person that the transmissive body of the invention is preferably designed such that the optical signal reflects off each reflective surface (e.g. the collimation element and the redirection element) via total internal reflection (TIR). This requires each angle of incidence to be greater than the critical angle θ_{c}, given by sin θ_{c}=n₂/n₁, where n₁ is the refractive index of the material from which the transmissive body is composed and n₂ is the refractive index of the surrounding medium. Most polymers have refractive index ˜1.5, so if the surrounding medium is air (i.e. n₂˜1.0), then θ_{c} will be approximately 42°. However, if the TIR condition cannot be satisfied, then the reflective surfaces can be metallised.

TIR relies on an interface with air or some other low refractive index medium and is relatively easily disrupted by foreign matter (solid or liquid) on the surface of the interface. For example even when the TIR surfaces are mechanically protected inside the device case it's possible for sudden changes in humidity or temperature to cause condensation on the TIR surfaces, potentially resulting in temporary signal drop out. Of course this is not a problem if the surfaces are metallised, since the optical field remains inside the transmissive body and never encounters the condensation droplets, but metallisation requires an extra process step. To address this issue, one embodiment of the present invention provides for the use of sealed chambers containing a medium of substantially different refractive index, such as dry air, which provide TIR surfaces for redirection of the optical signal. In this example, the optical signal is directed into a transmissive element and redirected by the sealed chambers to a Fresnel lens for collimating the optical signal. Clearly, sealed chambers will not suffer from condensation issues, especially if the chambers are evacuated prior to sealing or flushed with an inert and/or dry gas, such as nitrogen.

According to an eighteenth aspect the present invention provides a transmissive body comprising:

(a) a transmissive element adapted to receive, confine and transmit an optical signal in planar form;
(b) a collimation element adapted to substantially collimate an optical signal; and
(c) a redirection element adapted to redirect an optical signal,
wherein said elements are arranged to receive an optical signal from an optical source and transmit, collimate and redirect said optical signal to produce a substantially collimated signal in a substantially planar form,
wherein said redirection element includes at least one sealed chamber containing a medium with refractive index different to the refractive index of the surrounding portion of said transmissive body.

Preferably the collimation element is a segmented reflector, a segmented lens or a diffractive grating. Preferably the segmented lens is a Fresnel lens.

Preferably the medium is dry air or nitrogen.

As the skilled person will appreciate, it is desirable to reduce not only the bezel width but also the bezel height. It will be understood that the thickness (height) of the transmissive element typically determines the height of the exit facet, which contributes to bezel height. In a further embodiment of the present invention, the relative height of the exit facet may be reduced compared to the thickness of the transmissive element by reducing the width of the upper portion of the redirection element with one or more steps. However, a disadvantage is the loss of some signal light through the steps.

According to a nineteenth aspect the present invention provides a signal production device for a touch input device, comprising:

(a) a transmissive body comprising:
(i) a planar transmissive element having opposing first and second sides and opposing third and fourth sides and adapted to receive, confine and transmit optical signals in substantially planar form; and
(ii) a redirection element positioned adjacent said first side of said planar transmissive element;

(b) first and second optical sources spaced apart and positioned along said second side of said planar transmissive element; and

(c) light detection means positioned adjacent said second, third and fourth sides of said planar transmissive element, the arrangement being such that light supplied by said first and second optical sources is received, confined, transmitted and redirected into corresponding first and second substantially planar optical signals propagating in a plane substantially parallel to a plane of said planar transmissive element, and being received in said light detection means.

Preferably the optical sources producing the optical signals are point sources emitting diverging optical signals, for example LEDs.

The redirection element is preferably a turning prism formed separately from the planar transmissive element. In a preferred form the light detection means comprises a plurality of optical waveguides in optical communication with one or more multi-element detectors. Preferably, the first and second optical sources are disposed proximate to the corners at the extremities of the second edge.

According to a twentieth aspect the present invention provides a signal production device for a touch input device, comprising:

(a) a transmissive body comprising:
(i) a planar transmissive element having opposing first and second sides and opposing third and fourth sides and adapted to receive, confine and transmit optical signals in substantially planar form;
(ii) a first redirection element positioned adjacent said first side of said planar transmissive element; and
(iii) a second redirection element positioned adjacent said third side of said planar transmissive element;

(b) light detection means positioned adjacent said second and fourth sides of said planar transmissive element; and

(c) first, second and third optical sources, said first and second optical sources facing said first redirection element, and said third optical source facing said second redirection element, the arrangement being such that light supplied by said first, second and third optical sources is received, confined, transmitted and redirected into corresponding first, second and third substantially planar optical signals propagating in a plane substantially parallel to a plane of said planar transmissive element, and being received in said light detection means.

The first and second redirection elements are preferably turning prisms formed separately from the planar transmissive element. In a preferred form the light detection means comprises a plurality of optical waveguides in optical communication with one or more multi-element detectors.

Finally, it will be appreciated that the foregoing embodiments are not only useful for producing a signal for an input device but also for illuminating a display.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of ‘including, but not limited to’.

Other than in the operating examples, or where otherwise indicated, all numbers expressing quantities used herein are to be understood as modified in all instances by the term ‘about’. The examples are not intended to limit the scope of the invention.

### BRIEF DESCRIPTION OF THE DRAWINGS

Preferred embodiments of the invention will now be described, by way of example only, with reference to the accompanying drawings in which:

FIG. 1 shows a plan view of a prior art waveguide-based infrared touch input device;

FIG. 2 shows a plan view of a prior art infrared touch input device including a light pipe on the transmit side;

FIG. 2A shows a plan view of a prior art infrared touch input device including parabolic reflectors;

FIG. 2B shows a plan view of a prior art optical touch input device;

FIG. 3 shows a plan view of a transmissive body according to a first embodiment of the invention, shown optically coupled to an optical source and a substantially collimated planar signal being produced;

FIG. 4 is a side view of the apparatus as shown in FIG. 3;

FIG. 5 is a perspective view of the apparatus as shown in FIG. 3;

FIGS. 6A, 6B and 6C are plan, side and perspective views respectively of a transmissive body according to a first preferred embodiment;

FIGS. 7A, 7B and 7C are plan, side and perspective views respectively of a collimation/redirection element according to a further preferred embodiment;

FIG. 8 is a side view of a transmissive body including the collimation/redirection element of FIGS. 7A, 7B and 7C;

FIG. 9 is a side view of another transmissive body including the collimation/redirection element of FIGS. 7A, 7B and 7C;

FIG. 10A illustrates in plan view the incorporation of a transmissive body as shown in FIG. 3 into a touch input device;

FIG. 10B illustrates in plan view how a touch input device can fail if the optical source is incorrectly placed during assembly;

FIG. 10C shows in plan view an array of LEDs for transmitting light into a transmissive body according to an embodiment of the present invention, wherein the particular LED closest to the focal point is being used to emit light;

FIG. 10D is a view similar to FIG. 10C, wherein multiple LEDs are used to launch light into a transmissive body according to one embodiment of the invention, thereby relaxing the tolerance of the LED placement relative to the focal point (and tolerance of shape of the collimation element);

FIG. 11A is a view similar to FIG. 10B but with LEDs deliberately positioned off-axis to produce a pair of substantially collimated signals each propagating at an angle to the focal axis;

FIG. 11B is a view similar to FIG. 11A, however a mirror has been provided to reflect off-axis light back across the transmissive element;

FIG. 11C is a view similar to FIG. 11A, but with the provision of two mirrors to reflect off-axis light back across the transmissive element, thereby providing a grid of intersecting light paths suitable for touch sensing in two dimensions;

FIG. 11D shows a prior art two-dimensional touch system with a Cartesian grid of intersecting light paths;

FIG. 12A is a view similar to FIG. 11C, but showing three LED point light sources for providing three sheets of light propagating at different angles with respect to each other;

FIG. 12B is a view similar to FIG. 12A but showing beam paths within the three sheets of light;

FIG. 13A illustrates the occurrence of a double touch ambiguity in an infrared touch system;

FIG. 13B illustrates how the double touch ambiguity can be resolved by providing sensing beams in a third direction;

FIG. 14A (side view) and 14B (plan view) show a transmissive body according to one embodiment of the present invention wherein the collimation and redirection elements are positioned on opposite sides of a transmissive element;

FIG. 15 shows a side view of a transmissive body according to one embodiment of the present invention including an angled output facet;

FIGS. 16A and 16B shows a side view and an end view respectively of a transmissive body according to one embodiment of the present invention;

FIG. 17 shows a plan view of a transmissive body according to one embodiment of the present invention, wherein the collimation element is in the form of a segmented lens;

FIGS. 18 to 25 show in side view various further embodiments of the present invention wherein the collimation element is in the form of a segmented lens;

FIGS. 26 and 27 show in side view various embodiments of the invention having environmentally protected reflectors;

FIG. 28 shows in side view an embodiment of the present invention wherein the redirection element is in the form of a pair of 45° metallised surfaces;

FIG. 29 shows in side view an embodiment according to the present invention providing for reduced bezel height;

FIGS. 30A and 30B show a plan view and a side view respectively of a touch input device according to one embodiment of the present invention;

FIG. 31 shows a schematic of the touch input device of FIGS. 30A and 30B, with the optical paths folded out;

FIG. 32 shows a schematic of a possible receive side waveguide layout for the touch input device of FIGS. 30A and 30B;

FIG. 33 shows a schematic of another possible receive side waveguide layout for the touch input device of FIGS. 30A and 30B;

FIG. 34 shows a side view of two stacked waveguide structures, and

FIG. 35 shows a plan view of a touch input device according to one embodiment of the present invention.

### DEFINITIONS

In describing and claiming the present invention, the following terminology will be used in accordance with the definitions set out below. It is also to be understood that the terminology used herein is for the purpose of describing particular embodiments of the invention only and is not intended to be limiting. Unless defined otherwise, all technical and scientific terms used herein have the same meaning as commonly understood by one having ordinary skill in the art to which the invention pertains.

The terms ‘plane’, ‘sheet’ and ‘lamina’ may be used interchangeably herein. These terms have been used when referring to the physical dimensions of an optical signal and are intended to denote the substantial collimation or confinement of a beam of light such that the individual rays of light are travelling together along a well-defined substantially parallel path. Preferably the light signal is collimated such that, in cross-section, the plane/sheet/lamina is substantially rectangular. However, it will be appreciated that the present invention is not limited to that profile, and other profiles such as rhomboids etc are within the scope of the invention.

The term ‘substantially’ when used throughout the specification, for example in the term ‘substantially collimated signal’, is intended to refer to a degree of variation that would be consistent with what a person skilled in the art would understand would arise from natural variation in optical devices as described herein. The use of the word ‘substantially’ to qualify a number or an expression is merely an express indication that the number/expression is not to be construed as a precise value.

### PREFERRED EMBODIMENTS OF THE INVENTION

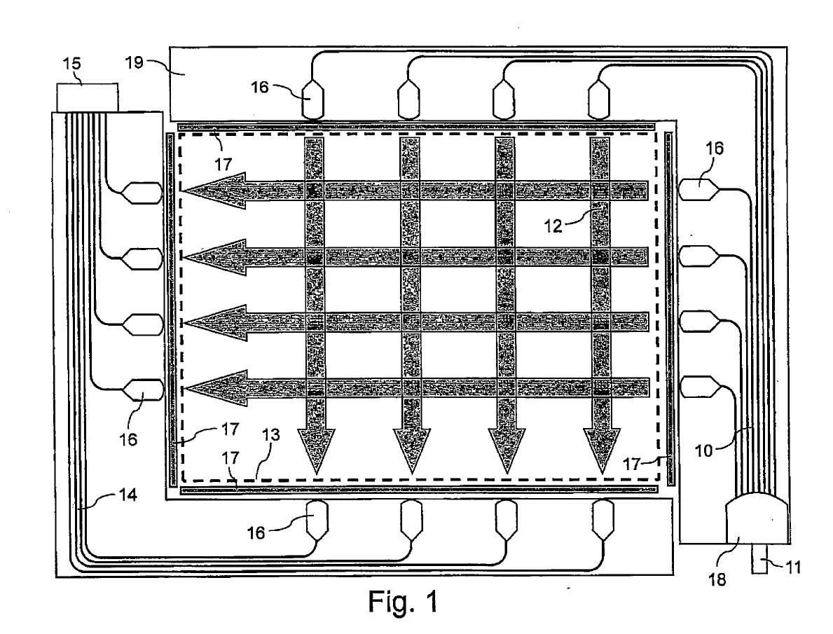

References will now be made to the drawings wherein like reference numerals refer to like parts throughout. As mentioned previously, waveguide-based optical touch screen sensors of the type shown in FIG. 1 tend to suffer from a signal to noise problem, where their performance is impaired in bright ambient light conditions. There is also a need to reduce costs, especially in the arrays of transmit waveguides 10 and receive waveguides 14, and to avoid the requirement to align the transmit and receive waveguides carefully during assembly.

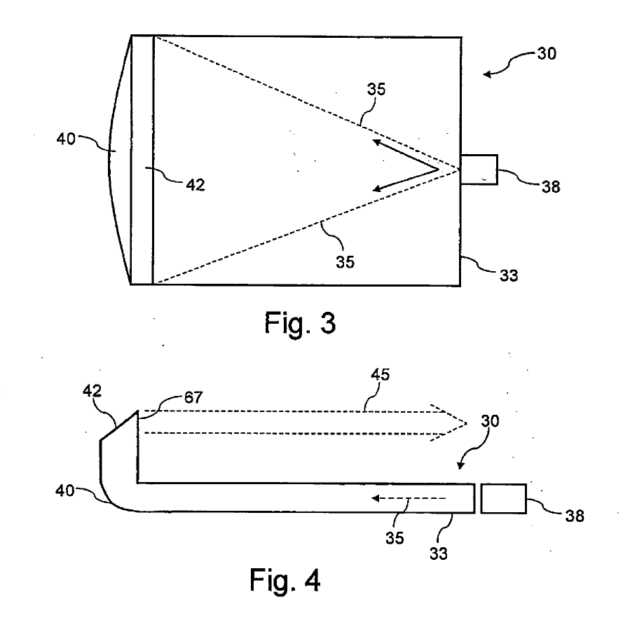

FIGS. 3, 4 and 5 show plan, side and perspective views respectively of a substantially planar transmissive body 30 for an input device according to a first embodiment of the invention. The transmissive body 30 comprises a transmissive element 33 adapted to receive, confine and transmit in planar form an optical signal 35 from an optical source 38. The transmissive body 30 further comprises a collimation element 40 adapted to substantially collimate the optical signal 35, and a redirection element 42 adapted to redirect the optical signal. These elements are arranged to receive an optical signal 35 and convert and transmit it as a substantially collimated signal 45 in a substantially planar form from an exit face 67. It will be appreciated that the divergence angle of the optical signal 35 emitted from the optical source 38 and confined within the transmissive element 33 should be large enough such that the entire width of the collimation element 40 and redirection element 42 is ‘filled’ (i.e. illuminated). Generally the divergence angle will be sufficiently large for the collimation element and redirection element to be somewhat ‘over-filled’, at the expense of some loss of light.

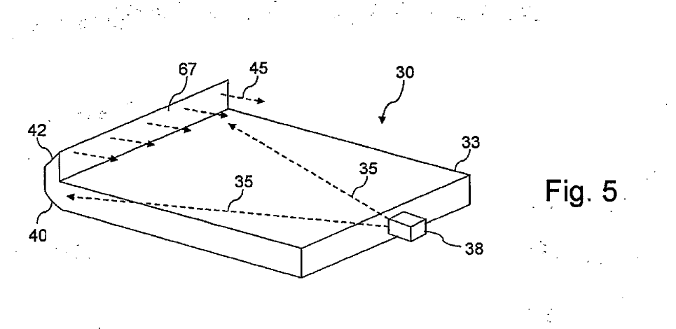

In the embodiment as shown in FIG. 5, a substantially collimated planar signal 45 is redirected in a plane substantially parallel to the transmissive element 33 and directed back towards the optical source 38.

Those skilled in the art will appreciate that the concept of a ‘point source’ is an idealisation, since the light-emitting surface of any real optical source will have non-zero dimensions. For the purposes of this specification, an optical source 38 will be considered to be a point-like source if its light-emitting surface is small compared to at least one dimension of the transmissive body 30.

It will be appreciated that the collimation element 40 should be angled so as to direct the light towards the redirection element 42. It will be appreciated that the order of the collimation element 40 and the redirection element 42 could be reversed. Alternatively, the collimation element and redirection element may be combined into a single ‘collimation/redirection element’ that performs both the collimation and redirection functions.

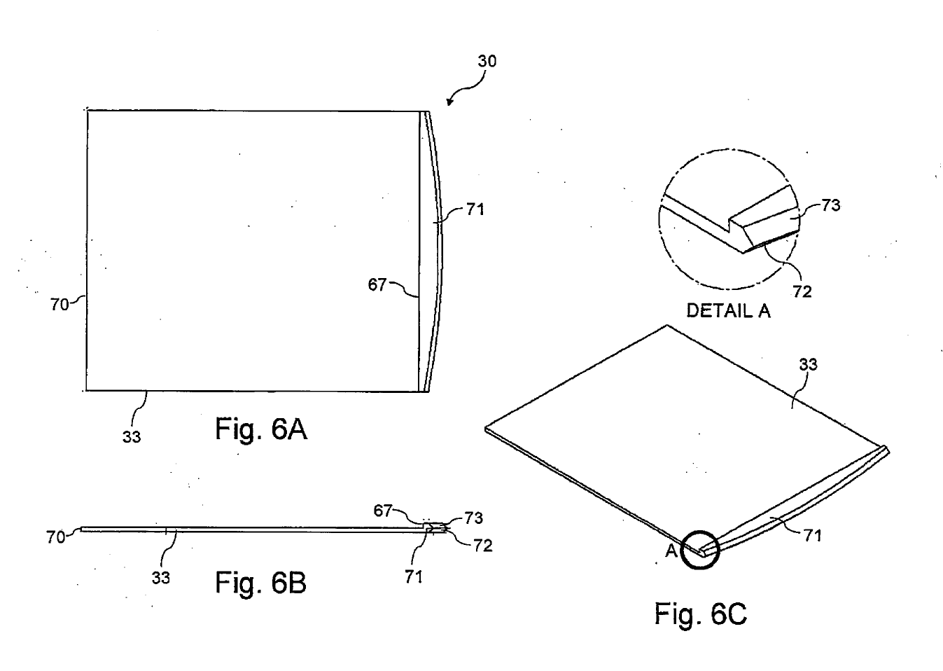

In certain preferred embodiments a transmissive body 30 is formed from a unitary piece of plastics material substantially transparent to the signal light. Preferably the signal light will be in the infrared region of the spectrum so that the transmissive body may optionally be opaque to ambient visible light. A unitary transmissive body 30 with realistic scaling is shown in FIGS. 6A (plan view), 6B (side view) and 6C (perspective view). This unitary transmissive body includes a transmissive element 33 with planar dimensions 65 mm×82 mm and thickness 0.7 mm, and having an entry face 70 for accepting light from a point-like source and a collimation/redirection portion 71 with two internally reflective facets 72, 73 and an exit face 67 through which a substantially collimated planar signal is emitted. The exit face 67 extends 0.7 mm above the transmissive element 33. The internally reflective facets 72, 73 in combination have substantially parabolic curvature and serve to collimate and redirect light guided by the transmissive element 33. That is, the internally reflective facets in combination act as a collimation element and a redirection element. This unitary transmissive body is relatively simple to produce from a plastics material by injection moulding. From comparison with FIGS. 3, 4 and 5 it will be appreciated that the specific transmissive body shown in FIGS. 6A, 6B and 6C will only produce a collimated signal 45 propagating in a single direction. However this is for simplicity of illustration only and it is straightforward to produce a bi-directional version with two collimation/redirection portions 71 on adjacent sides of the transmissive element 33.

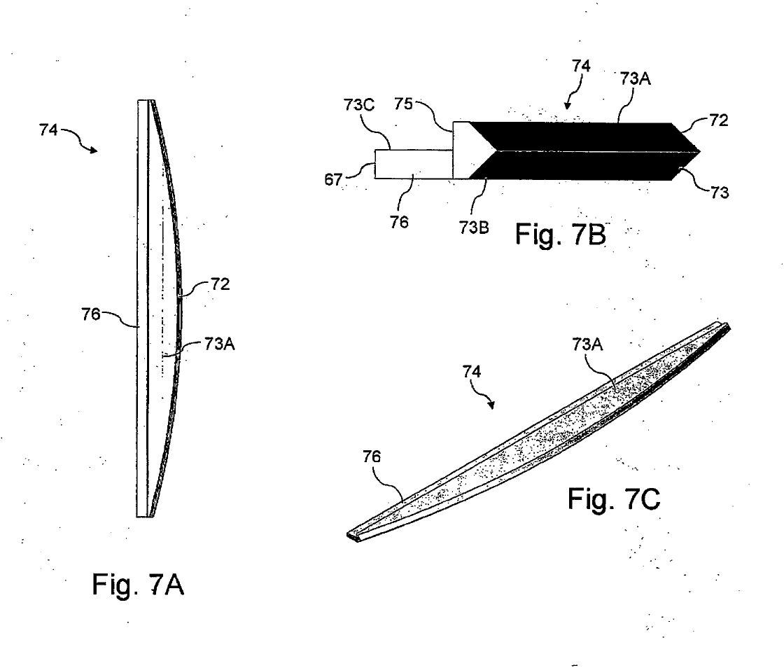

In other preferred embodiments a transmissive body is formed as a pair of bodies, with a transmissive element and a collimation/redirection element manufactured separately. As shown in FIGS. 7A (plan view), 7B (side view) and 7C (perspective view), a collimation/redirection element 74 produced from a plastics material by injection moulding includes an entry face 75 for receiving light from a separate transmissive element, a pedestal 76 for mounting the transmissive element, and two internally reflective facets 72, 73 and an exit face 67 that function as described with respect to FIGS. 6A, 6B and 6C. In one specific design, the entry face 75 and exit face 67 are each 65 mm×0.7 mm and the pedestal 76 extends 3 mm from the entry face. In the embodiment shown in FIG. 7B the surfaces 73A and 73B are both parallel to the surface 73C, while in an alternative embodiment they are both angled slightly, of order 1°, with respect to the surface 73C, so as to be further from that surface at the end constituted by the reflective facets 72, 73. This is to assist in releasing the element 74 from a mould, and does not significantly affect the collimation/redirection performance of the element.

In one embodiment, the transmissive body as shown in FIGS. 7A (plan view), 7B (side view) and 7C (perspective view) comprises an entry face for receiving a divergent optical signal from an optical source; a collimation and redirection element adapted to substantially collimate and redirect the optical signal; and an exit face for transmitting the optical signal as a substantially collimated signal in a substantially planar form. In another embodiment the transmissive body comprises: an entry face for receiving divergent light from an optical source; a collimation element adapted to substantially collimate the optical signal; a redirection element adapted to redirect the optical signal; and an exit face for transmitting the optical signal as a substantially collimated signal in a substantially planar form. Preferably, the transmissive body further comprises a coupling means for optically coupling a substantially planar transmissive element to the entry face, wherein the divergent light is diverging in the plane of the transmissive element. Preferably the coupling means includes a pedestal. Preferably the substantially collimated planar signal is redirected in a plane parallel to the plane of the transmissive element.

In another aspect, the present invention provides an assembly for an input device comprising: a transmissive element 33 adapted to receive an optical signal 35 from an optical source 38 and confine and transmit the optical signal 35 in substantially planar form into a transmissive body comprising a collimation element adapted to substantially collimate an optical signal, and a redirection element adapted to substantially redirect an optical signal, wherein the elements are arranged to receive a substantially planar optical signal and collimate and redirect the optical signal to produce a substantially collimated planar signal. Preferably the transmissive element is an outer glass or plastic plate of a touch screen or display.

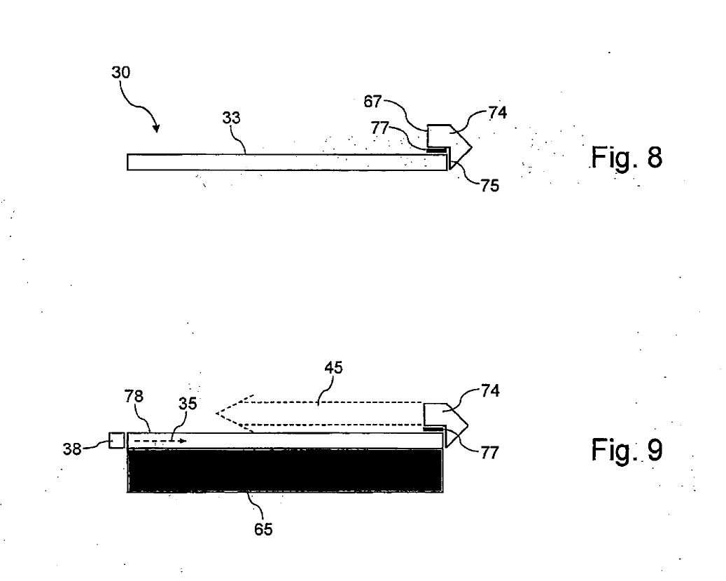

As shown in FIG. 8, a transmissive body 30 is produced by joining a collimation/redirection element 74 to a transmissive element 33 using double-sided pressure-sensitive tape 77 such as a VHP transfer tape from 3M. If desired, the interface between the transmissive element and the entry face 75 can be filled with an optical adhesive. In this embodiment the transmissive element 33 consists of a simple rectangular sheet of glass that is more scratch resistant and provides more robust protection for an underlying display than if it were composed of a plastics material. However as described below there are situations where the transmissive element is preferably formed of a plastics material. It will be appreciated that a bi-directional transmissive body can be produced by joining two collimation/redirection elements 74 to adjacent sides of a transmissive element 33. Alternatively, a single L-shaped collimation/redirection element could be moulded and joined to a transmissive element.

In situations where a touch input device includes a display with a transparent cover such as a protective glass sheet, this cover can serve as the transmissive element. In the embodiment shown in FIG. 9, a collimation/redirection element 74 is attached with double-sided tape 77 to a protective glass cover 78 of a liquid crystal display 65, such that light 35 launched into the glass cover from a point-like source 38 is collimated and redirected by the element 74 to produce a substantially collimated planar signal 45.

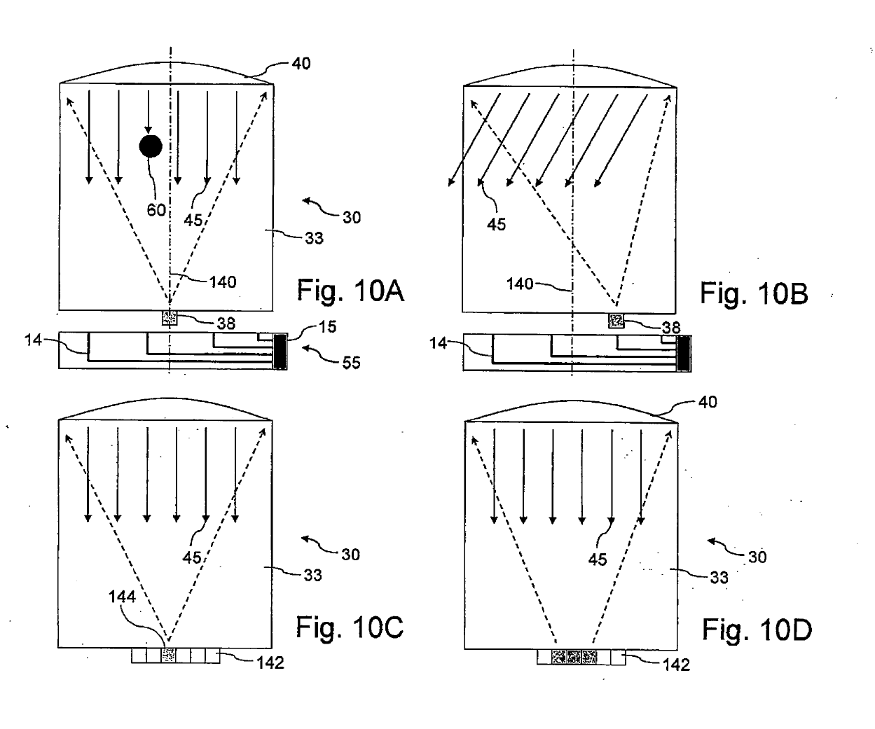

FIG. 10A illustrates the incorporation of a transmissive body 30 as shown in FIGS. 3 to 5 into a touch input device, where a light detecting means 55 in the form of an array of ‘receive’ waveguides 14 is positioned adjacent an edge of a transmissive element 33 and configured to conduct portions of the substantially collimated planar signal 45 to a multi-element detector 15, such that partial blockage of the planar signal by a touch object 60 enables that object's location (in one dimension) to be determined. The extension to two dimensions (as illustrated in the prior art system of FIG. 1) is described in WO 08/138,049 A1. For clarity, the in-plane focussing lenses associated with the receive waveguides (see FIG. 1) have been omitted, and the receive waveguide array displaced away from the transmissive element to show the optical source 38 (for example an LED). It will be appreciated that successful operation of this touch input device is dependent, in part, upon positioning the LED point source at the focal point of the substantially parabolic collimation element 40 so that the collimated planar signal 45 propagates parallel to the focal axis 140 of the collimation element and is accepted by the receive waveguides 14. If as shown in FIG. 10B the LED is ‘incorrectly’ positioned on either side of the focal point then the planar signal 45 will not be parallel to the axis 140 and will not be accepted by the receive waveguides. This light source positioning problem can be overcome to some extent by using an LED with a larger illumination area. However this introduces further problems, for example the efficiency is reduced because a smaller fraction of the light being generated is being effectively used (detrimental to the power budget), and the presence of out-of-focus light can create blurring of the light received by the collimation element.

To avoid the necessity of having to carefully position a single LED point light source, a small array 142 of individually controllable LEDs may be used as shown in FIG. 10C, and the apparatus configured to activate the LED 144 that gives the best system performance, generally the LED closest to the focal point of the collimation element. This could be done during assembly of a touch input apparatus including a transmissive body of the invention, or dynamically during operation of the apparatus, using a computer algorithm to test which individual LED or combination of LEDs gives the best system performance. Dynamic determination could be useful to compensate for warping of the apparatus during temperature excursions, and to extend operation of the apparatus should an LED fail.

A combination of LEDs may be activated to relax the tolerance in the shape of the collimation element 40 (illustrated in FIG. 10D), or to boost signal level if required.

The small additional cost of including a LED array as opposed to a single LED point light source is offset by the flexibility such a configuration provides. It will be appreciated that precise positioning of a point source of light is less important when the transmissive body of the invention is being utilised to direct light into an assembly for illuminating a display, as described in WO 08/138,049 A1.

In the embodiments discussed in the foregoing, a point source of light has been used to deliver an optical signal to the transmissive body of the invention to produce a substantially collimated signal in a substantially planar form. In these embodiments the point source of light has been preferably positioned at the focal point of the collimation element.

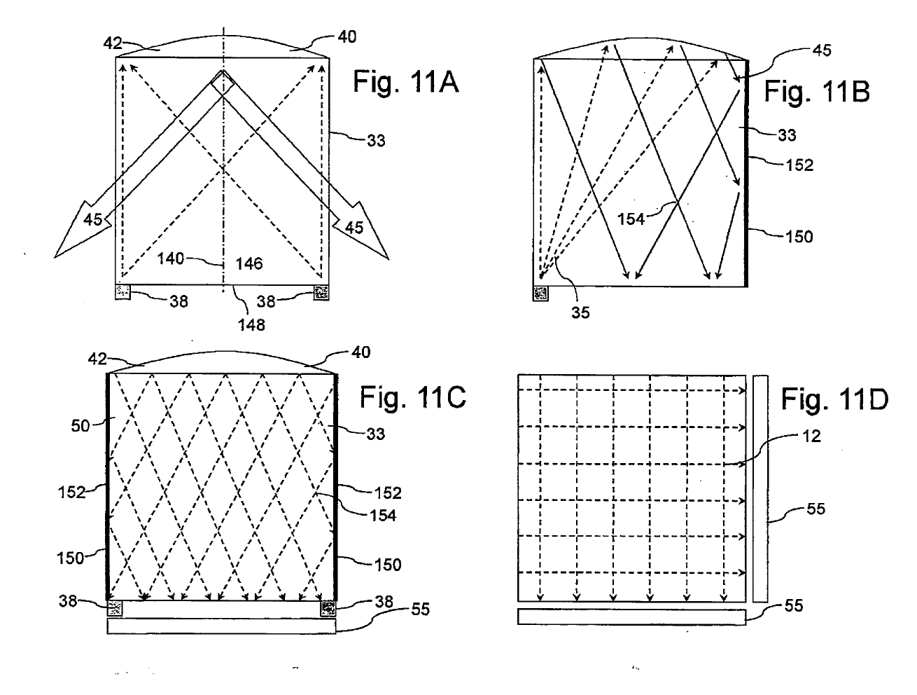

In an alternative embodiment however, the point source of light may be deliberately positioned ‘off axis’. In one example of this embodiment, shown in FIG. 11A, a point source 38 is positioned at or near one or both corners of a rectangular transmissive element 33 facing the collimation and redirection elements 40, 42. Optical modelling shows that the resultant planar signal(s) 45 remain(s) substantially collimated, but propagate(s) at an angle to the focal axis 140 of the collimation element (upon which the focus lies). It will be appreciated that this configuration would not be particularly effective when used in a touch input device, even if point sources were located in two corners, because of the existence of a region 146 close to one edge 148 of the transmissive element not accessed by the planar signals 45; a touch object in this region could not be detected.

If however a plane mirror 150 is placed alongside a lateral edge 152 of the transmissive element as shown in FIG. 11B, a portion of the planar signal 45 will reflect back across the transmissive element to produce an intersecting grid 154 of light paths located above a portion of the transmissive element. It should be recalled of course that the ‘outgoing’ light paths 35 are guided within the transmissive element and are therefore unavailable for touch sensing. Furthermore as shown in FIG. 11C if a pair of point sources 38 are placed at or near two corners of the transmissive element 33 (again facing the collimation and redirection elements 40, 42) and a pair of plane mirrors 150 placed alongside the lateral edges 152, an intersecting grid 154 of light paths will be established above the entire area of the transmissive element. It will be appreciated that for touch sensing purposes this grid is effectively equivalent to a Cartesian grid of light beams 12 (FIG. 11D) produced for example by the apparatus of FIG. 1. In the present case as shown in FIG. 11C a light detecting means 55 is only required along a single side of the transmissive element/input area, rather than along two sides as in FIG. 11D. If the light detecting means includes optical waveguides 14 and in-plane lenses 16 as per FIG. 1, individual waveguides and lenses will have to be correctly angled to receive light from one of the two directions and may need to pass through each other depending on their pitch (determined by the required spatial resolution). However provided the crossing angle is greater than 10° or so this is not an obstacle either in terms of waveguide fabrication or optical cross-talk. Alternatively, two sets of appropriately angled waveguides could be fabricated on separate substrates, and the waveguides stacked. Either way, the waveguides can be laid out such that their distal ends are in optical communication with a multi-element detector at one end of the substrate as shown in FIGS. 10A and 10B, or with multi-element detectors located at both ends of the substrate.

One advantage of the FIG. 11C embodiment is that a single collimation element can be used to generate a two dimensional grid of light paths for touch sensing, however the primary advantage is substantially reduced bezel width on the lateral sides. It will be appreciated that when this embodiment is used in an input device the plane mirrors 150 will have to be placed parallel to the sides of the input area 50, but the required alignment will be facilitated by the ‘hard stop’ provided by the lateral edges of the transmissive element 33.

In the foregoing embodiments, wherein the source of light is positioned off-axis, it will be appreciated that the resultant planar sheet of light will not be perfectly collimated by a parabolic reflector. However optical modelling shows that this will be a relatively small effect and that the individual rays of light will be sufficiently parallel to be useful in the foregoing methods of the invention. Of course it will be possible to accommodate for any significant deviations by appropriately angling the elements of the light detecting means.

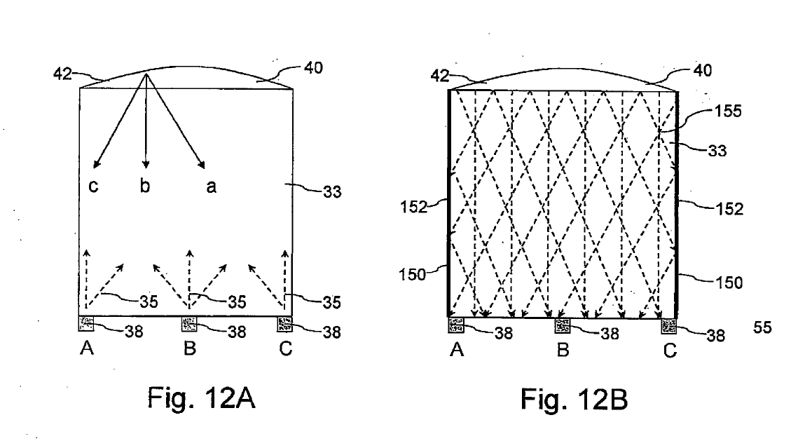

In a further embodiment shown in FIG. 12A, it is possible to include three point sources 38, for example one (B) positioned at the focus of the collimation element 40 and the other two (A and C) at or near two corners of the transmissive element 33. The collimation element 40 and redirection element 42 produce, from the outgoing light 35 guided within the transmissive element, three sheets of light (represented by the arrows labelled a, b and c) each propagating above the transmissive element in a different direction. Furthermore with the addition of plane mirrors 150 along the lateral sides 152 of the transmissive element 33, this configuration provides a grid of light 155 with light paths extending in three directions as shown schematically in FIG. 12B. Naturally if this configuration were used in a touch input device the light detecting means would need to have elements aligned to receive light from each of the three directions. For example the light detecting means could comprise three sets of appropriately angled waveguides on stacked substrates, or sets of waveguides angled to receive light from all three directions on a single substrate.

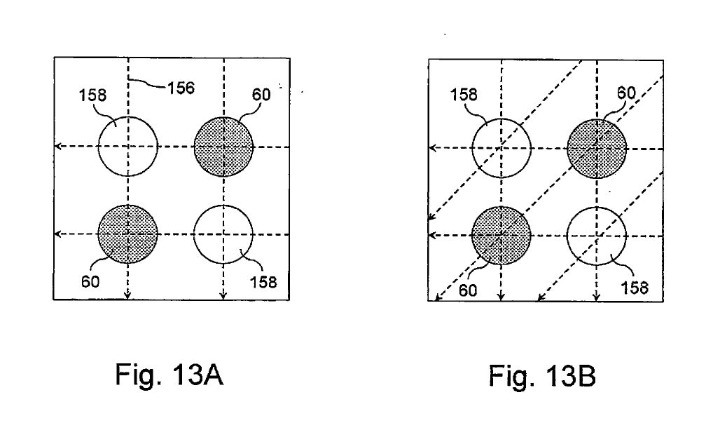

The usefulness of this scheme will be explained in terms of the so-called ‘double touch ambiguity’. As described in U.S. Pat. Nos. 6,723,929 and 6,856,259 for example, it is known that touch input devices that rely on shadowing or reflection of two beam paths (e.g. of light or ultrasonic waves) to locate a touch object are able to detect the presence of two simultaneous touch events, but are in general unable to determine their locations unambiguously. For example as shown in FIG. 13A the shadowing of four Cartesian beam paths 156 by two touch objects 60 produces four ‘candidate points’ including two ‘phantom’ points 158 that cannot, without more information, be distinguished from the real touch objects. Inspection of the ‘skewed’ beam grid 154 in FIG. 11C shows it will suffer from the same ambiguity, except the four candidate points will lie at the corners of a parallelogram rather than a rectangle. As shown schematically in FIG. 13B, the presence of beam paths in a third direction breaks the ambiguity, allowing the two touch objects 60 to be distinguished from the ‘phantom points’ 158. The scheme shown in FIG. 12B is somewhat similar to those disclosed in U.S. Pat. No. 6,723,929 and US Patent Publication No US 2006/0232792 A1, but with the tri-directional beam grid 155 generated in completely different fashion.

It will be appreciated from the foregoing that there is considerable flexibility as to how the various components of the transmissive body of the invention, i.e. the collimation element, redirection element and transmissive element (if present) are combined. For example the transmissive body shown in FIGS. 6A-6C is formed as a unitary body including a planar transmissive element 33 and a combined collimation/redirection element 71, while the transmissive body shown in FIG. 8 includes a combined combination/redirection element 74 and a separate planar transmissive element 33.

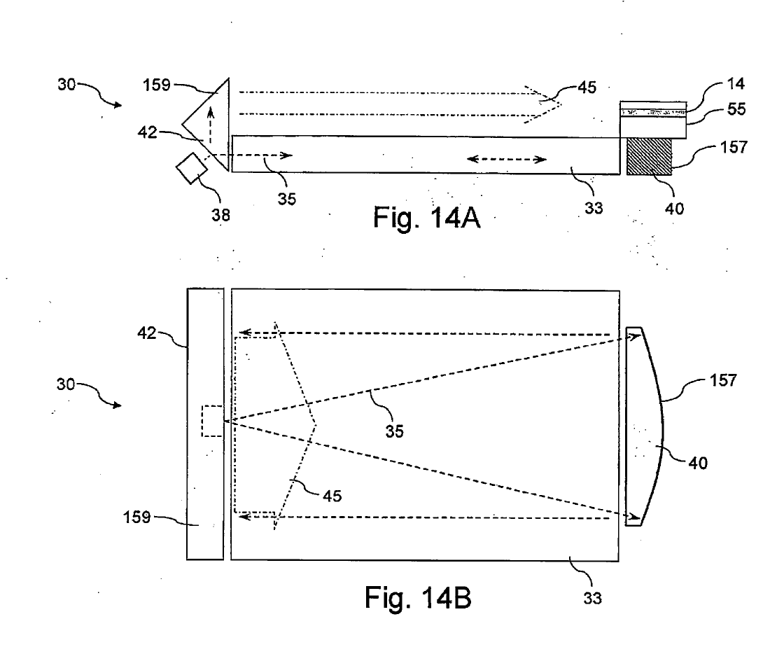

In a further variant embodiment shown in FIGS. 14A (side view) and 14B (plan view), a transmissive body 30 includes a collimation element 40 in the form of a metallised parabolic reflector 157 and a redirection element 42 in the form of an elongated 45° prism 159 positioned on opposite sides of a planar transmissive element 33. Light 35 from a point source 38 is introduced through the prism into the transmissive element, collimated by the parabolic reflector and propagates back through the transmissive element to the prism where it is redirected to form a substantially collimated planar signal 45 propagating above and parallel to the transmissive element towards a light detecting means 55 including waveguides 14 (not shown in FIG. 14B). In this embodiment the width of the parabolic reflector determines the width of the collimated planar signal 45, because the 45° prism simply redirects the light. The interfaces between the various elements can be filled with an optical adhesive or similar to minimise optical loss if desired. In another variation the collimation task could be divided between the reflector and the prism, in which case the reflector would not be parabolic and the prism would need to have a degree of in-plane curvature.

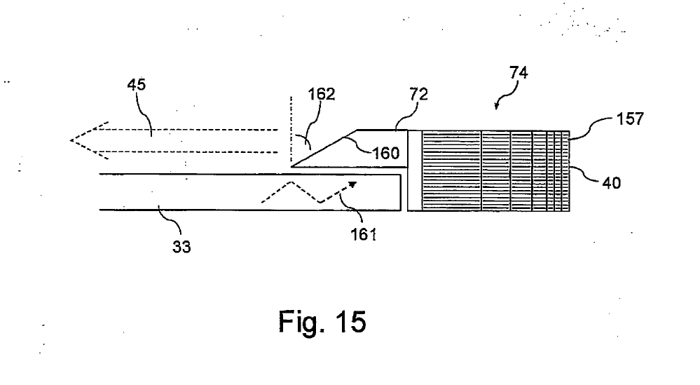

FIG. 15 shows yet another embodiment, wherein the collimation element and redirection element form a unitary body 74 positioned to receive light from a transmissive element 33. In this case the collimation element 40 is in the form of a metallised parabolic reflector 157 and the redirection element 42 includes an angled output facet 160. This embodiment takes advantage of the fact that a ‘bulk optics’ transmissive element 33 is sufficiently thick to support a large number of optical modes, equivalent in the ray optics picture to guidance of off-axis light rays 161 ‘bouncing’ along with a range of incidence angles. It will be appreciated that when the rays enter the body 74 they will tend to ‘move up’ (i.e. be partially redirected) before and after they encounter the parabolic reflector, before the redirection is completed by the angled output facet 160 to bring the light back down into the plane of the transmissive element 33, producing a substantially collimated planar signal 45 propagating above and parallel to the transmissive element. In the preferred embodiment shown in FIG. 15 the angled output facet is a refractive element, although in an alternative embodiment it could be an appropriately angled reflector.

Surprisingly, optical modelling indicates that this embodiment can provide an optical throughput (measured as the amount of light emitted from an optical source that is usefully converted into a collimated planar signal 45 for touch sensing) up to 40% higher than that provided by the embodiment shown in FIG. 9. The modelling results shown in Table 1 indicate that the facet angle 162 is an important design parameter, with 50° being close to optimal. The skilled person will appreciate that the parameter ‘No of hits’, being the output of the modelling program, is simply an indication of the amount of light that would be received by a light detecting means positioned on the other side of the transmissive element 33.

TABLE 1
Facet angle vs No of hits

| | | No of hits compared to |
|---|---|---|
| Facet angle (degrees) | No of hits | FIG. 9 design (%) |
| 0 | 177 | 4 |
| 10 | 1765 | 37 |
| 20 | 2845 | 59 |
| 30 | 3311 | 69 |
| 40 | 4856 | 101 |
| 45 | 5607 | 117 |
| 50 | 6755 | 140 |
| 60 | 5905 | 123 |
| 70 | 117 | 2 |

A further advantage of the angled output facet is that it can provide an angled bezel, which is preferred to a right angle bezel both aesthetically and to prevent dirt build up. It will be appreciated that an angled output facet is possible in other embodiments described herein. For example in the collimation/redirection element 74 shown in side view in FIG. 7B, an adjustment to the angle of one or both of the reflective facets 72, 73 would enable the output facet 67 to be tilted so as to redirect the collimated signal ‘back down’ parallel to the plane of an associated touch input area.

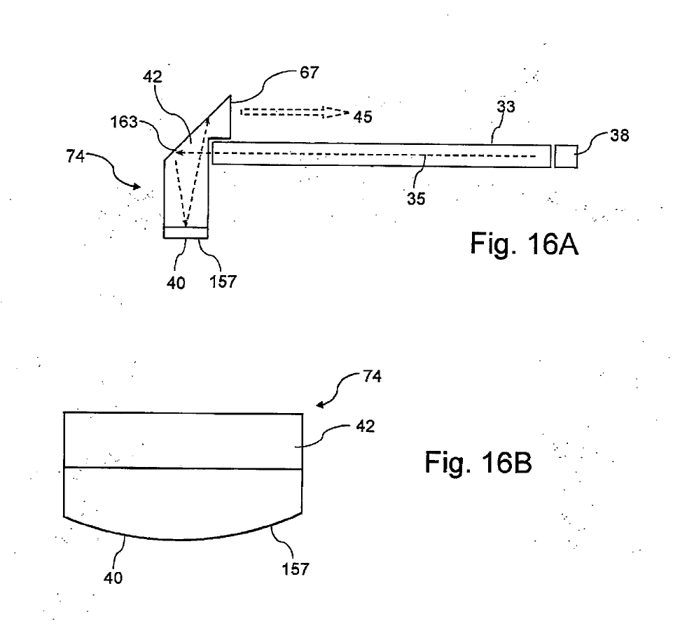

FIGS. 16A (side view) and 16B (end view) illustrate an embodiment similar to that shown in FIG. 15 in that the collimation element and redirection element form a unitary body 74 positioned to receive light from a transmissive element 33, and the collimation element 40 is in the form of a metallised parabolic reflector 157. In this case the redirection element 42 includes an angled facet 163 that redirects light 35 from an optical source 38 downwards towards the parabolic reflector 40, then redirects the collimated light out through the exit facet 67 to produce the collimated signal 45. It will be appreciated that the tilt angle of the facet 163 (or an appropriate portion of it) could be adjusted to enable the exit facet 67 to be angled, as in the previous embodiment. An advantage over that embodiment is reduced bezel width; a disadvantage is greater complexity.

As discussed in the foregoing, the collimation element of a transmissive body according to the invention is preferably a substantially parabolic reflector or a substantially elliptical lens. However it will be appreciated that a collimation element in the form of a parabolic reflector can be replaced with a segmented reflector (as described in WO 08/138,049 A1), and similarly a substantially elliptical lens can be replaced with a segmented lens (such as a Fresnel lens). An advantage of a segmented reflector or lens is that it provides a collimation element with reduced width compared to a collimation element in the form of a parabolic reflector or elliptical lens, which provides reductions in bezel width when used in an input device. Other variations of segmented lenses or reflectors are known to those skilled in the art, for example diffractive gratings.

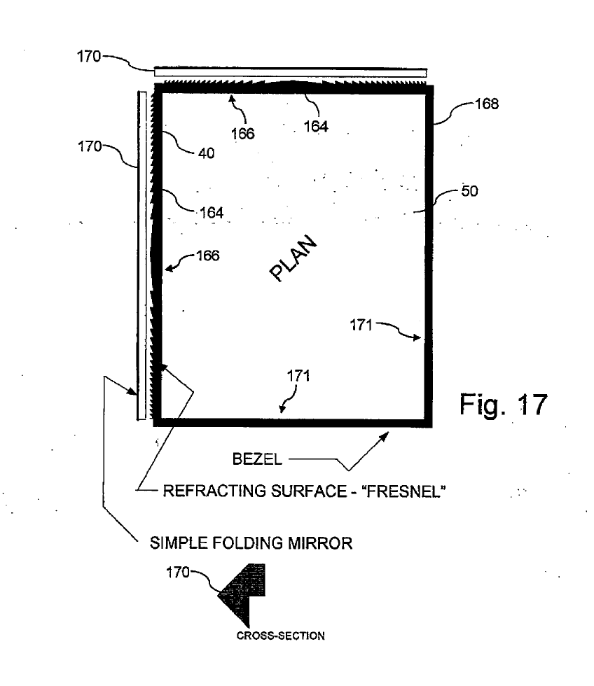

FIG. 17 shows, in plan view, selected components of a touch input device including a segmented lens as a collimation element. In this example embodiment the collimation element 40, including segmented lenses 164, forms two (‘transmit’) sides 166 of a frame-like bezel 168 that surrounds an input area 50, and the redirection element includes two folding mirrors/retro-reflectors 170 placed along the transmit sides. In operation, similar to the embodiments shown in FIGS. 8 and 9, signal light from a planar transmissive element (not shown) underlying the input area 50 will be redirected by the folding mirrors 170 into the segmented lenses 164 and thereby collimated to produce a pair of planar collimated signals for detection of a touch event on the input area. Alternatively, the signal light from the planar transmissive element could be collimated by the segmented lenses before being redirected by the folding mirrors. The portions of the bezel 168 along the two ‘receive’ sides 171 need not be present, but in preferred embodiments can have a variety of functions. For example they may provide environmental protection for detection optics (e.g. receive waveguides), have cylindrical curvature for out-of-plane focussing like the VCLs 17 shown in FIG. 1, or be opaque to visible light (assuming the signal light is in the infrared) to improve the signal-to-noise ratio.

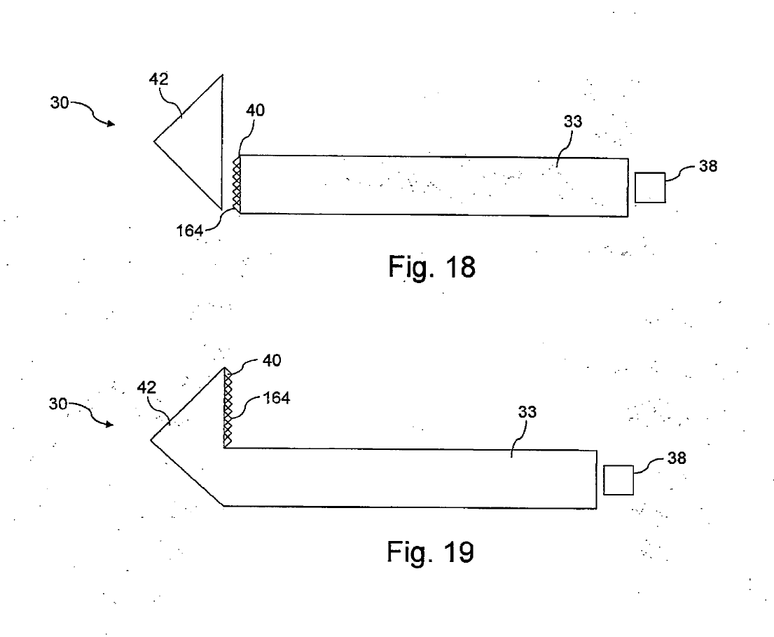

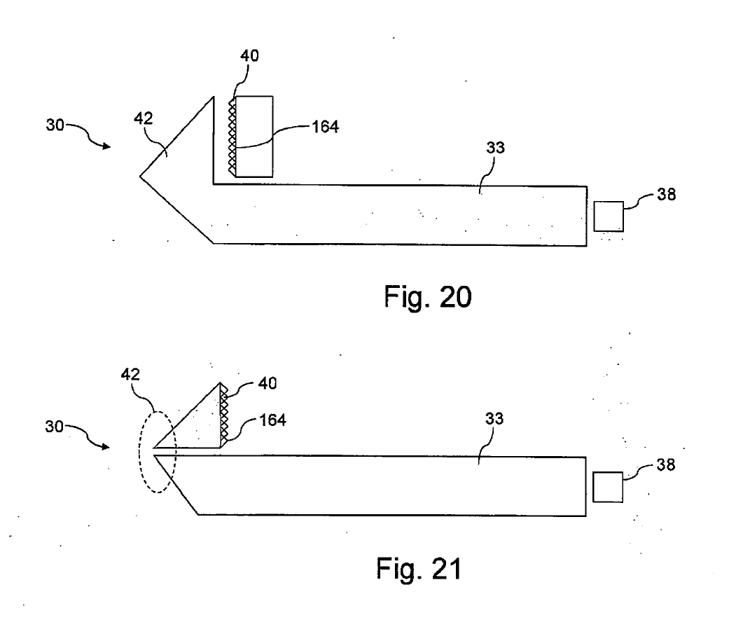

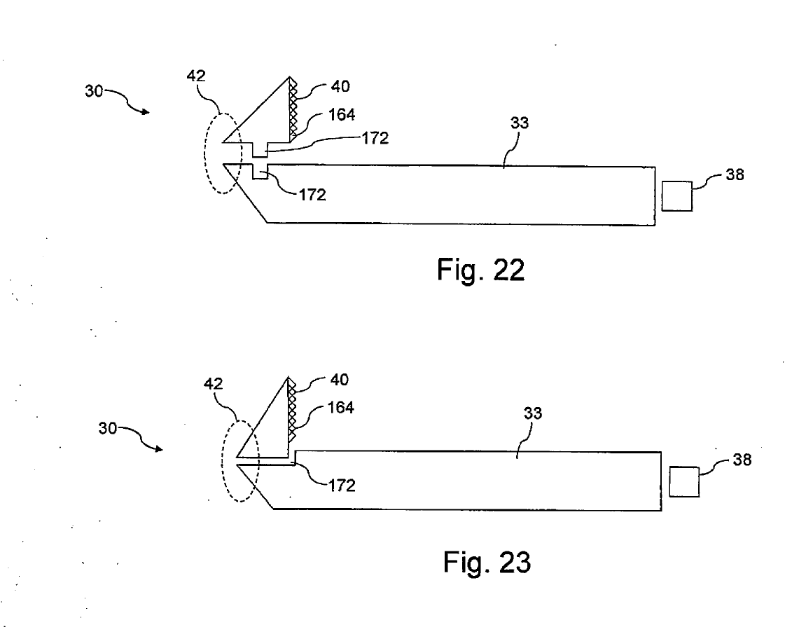

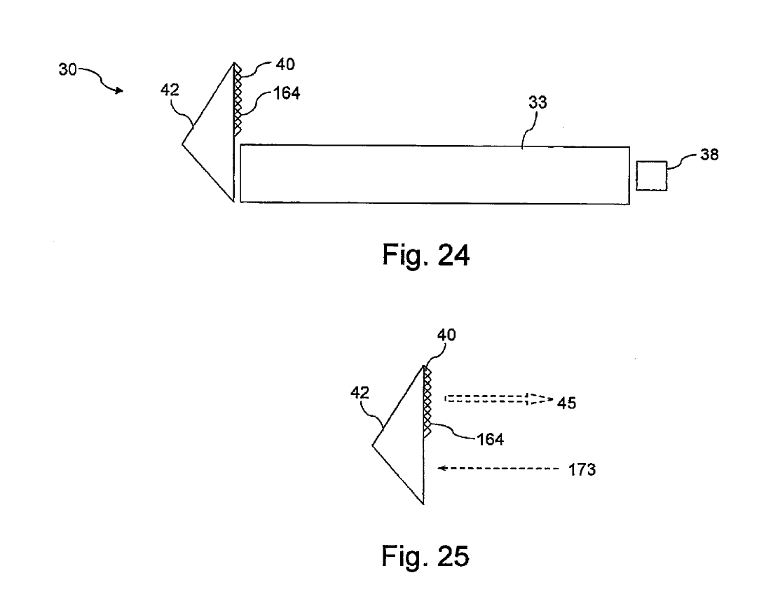

A large number of variant embodiments will occur to those skilled in the art, with a selection shown in side view in FIGS. 18 to 24. Each variant includes a transmissive element 33, a collimation element 40 and a redirection element 42, where the collimation element is in the form of a segmented lens 164. Each of FIGS. 18 to 24 also shows an optical source 38. The dashed ellipse in FIGS. 21 to 23 simply indicates that in those particular variants the redirection function is split between two separate portions of the transmissive body 30. The variant embodiments shown in FIGS. 22 and 23 demonstrate the use of positioning formations 172 such as projections, recesses and slots to assist in assembly of the elements. Preferably, the variations where the segmented lens is ‘outermost’ and therefore exposed (FIGS. 19, 21-24) would include an additional element such as a bezel to protect the lens from the environment.

In yet another variation, shown in FIG. 25, the transmissive element is omitted, and the collimation element 40 and redirection element 42 configured to receive a substantially planar optical signal 173 and collimate and redirect it to produce a substantially collimated planar signal 45.

In still another variation the segmented lenses 164 of FIGS. 17-25 could be replaced by a diffractive optical element such as a grating.

FIGS. 19-25 show configurations where the collimation element, in the form of a segmented lens 164, is ‘optically downstream’ from the redirection element 42 (in the form a one or two piece turning prism), whereas FIG. 18 shows a configuration where the collimation element is ‘optically upstream’ from the redirection element. One advantage of the FIG. 18 ‘collimate then redirect’ arrangement is that the distance between the optical source 38 and the collimation element, which should correspond to the focal length of the collimation element, is well defined by the length of the transmissive element 33, potentially relaxing the assembly tolerances.

It will be observed that in many of the exemplified embodiments of the transmissive body of the invention, the optical signal is able to reflect off each reflective surface (e.g. the collimation element or the redirection element) via total internal reflection (TIR). This requires each angle of incidence to be greater than the critical angle θ_{c}, given by sin θ_{c}=n₂/n₁, where n₁ is the refractive index of the material from which the transmissive body is composed and n₂ is the refractive index of the surrounding medium. Most polymers have refractive index ˜1.5, so if the surrounding medium is air (i.e. n₂˜1.0), then θ_{c} will be approximately 42°. In embodiments where the TIR condition cannot be satisfied (e.g. the collimation elements in the embodiments shown in FIGS. 14 to 16B) the reflective surfaces should be metallised.

Since TIR relies on an interface with air or some other low refractive index medium, it is relatively easily disrupted by foreign matter (solid or liquid) on the interface. This disruption can be used to advantage in sensors relying on frustrated TIR (FTIR) for example, but in the transmissive bodies of the present invention it would usually be disadvantageous. For example even when the TIR surfaces are mechanically protected inside the case of a touch input device it's possible for sudden changes in humidity or temperature to cause condensation on the TIR surfaces, potentially resulting in temporary signal drop out. Metallised surfaces are immune to this problem because the optical field remains inside the transmissive body and never encounters the condensation droplets, but metallisation requires an extra process step.

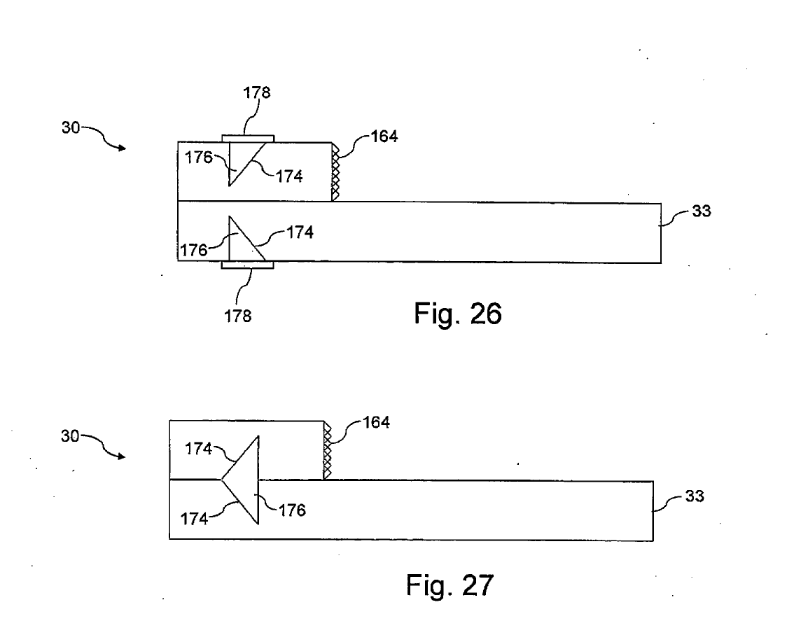

To address this issue, one embodiment of the present invention provides for the use of sealed cavities that act as TIR surfaces for providing redirection of the optical signal. FIG. 26 shows, in side view, a transmissive body 30 including a transmissive element 33, a redirection element in the form of two angled facets 174 formed by cavities 176 filled with a low refractive index medium such as dry air or nitrogen, a collimation element in the form of a segmented lens 164, and seals 178 for the cavities. Clearly TIR at the angled facets will not suffer from condensation problems, especially if the cavities are evacuated or flushed with an inert and/or dry gas such as nitrogen prior to sealing.

FIG. 27 shows an alternative configuration where the cavity 176 is filled with a high refractive index medium. It will be appreciated that if this cavity were filled with a low refractive index medium the angled facets 174 would need to be metallised because TIR cannot occur when the lower refractive index medium is on the incidence side of the interface.

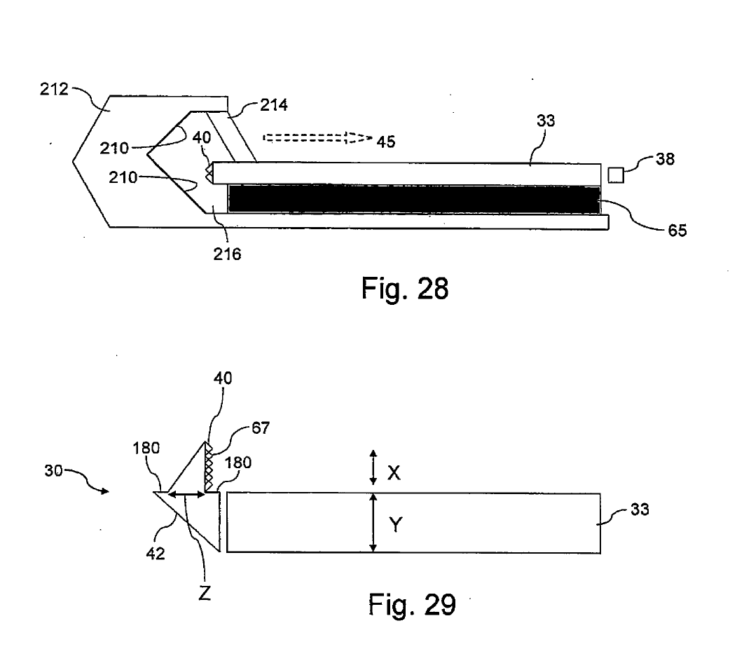

Potential problems with TIR disruption can also be circumvented by using metallised surfaces to reflect (and hence redirect) the signal light. One example configuration with metallised surfaces is shown in side view in FIG. 28, including a transmissive element 33 in the form of a glass sheet atop a display 65, a collimation element 40 in the form of a segmented elliptical lens, and a redirection element in the form of two 45° metallised surfaces 210 in a device casing 212. Light launched into the transmissive element from an optical source 38 is collimated by the collimation element 40 then redirected across the front of the transmissive element through the bezel 214 as the substantially collimated, substantially planar signal 45. The bezel is preferably angled as illustrated to help prevent dirt build up as discussed previously with reference to FIG. 15. However unlike the angled output facet 67 shown in FIG. 15, an angled bezel as shown in FIG. 28 will not affect the propagation direction of the signal 45 provided the cavity 216 is filled with air or some similar refractive index medium, which will generally be the case. It will be appreciated that the FIG. 28 configuration resembles the FIG. 18 schematic in that the collimation element is ‘optically upstream’ from the redirection element.

As the skilled person will appreciate, when a transmissive body of the invention is used in a touch input device it is desirable to reduce not only the bezel width but also the bezel height. Referring to the specific embodiment described in relation to FIGS. 7A-7C, the height of the exit face 67 (which contributes to bezel height) is equal to the thickness of the transmissive element 33 (0.7 mm), essentially because the redirection element includes two 45° angled facets 72, 73. Most of the exemplified embodiments have a similar constraint, with the exception of those shown in FIGS. 15 and 16A-16B. In a further embodiment of the present invention, shown in side view in FIG. 29, the relative height ‘X’ of the exit facet 67 can be reduced compared to the thickness ‘Y’ of the transmissive element 33 by reducing the width ‘Z’ of the upper portion of the redirection element 42 with one or more offsets 180. However a disadvantage is the loss of some signal light through the offsets.

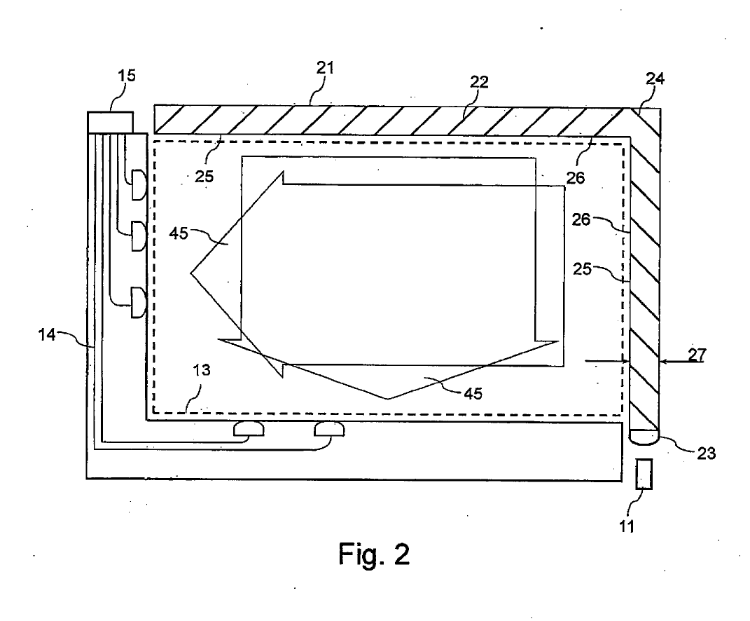

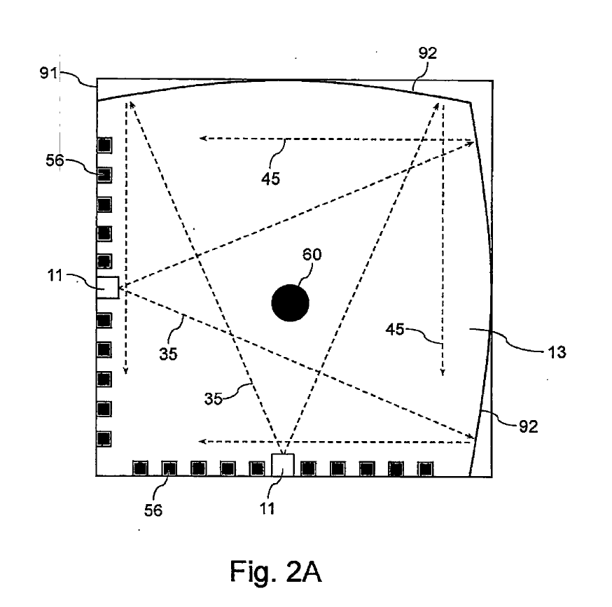

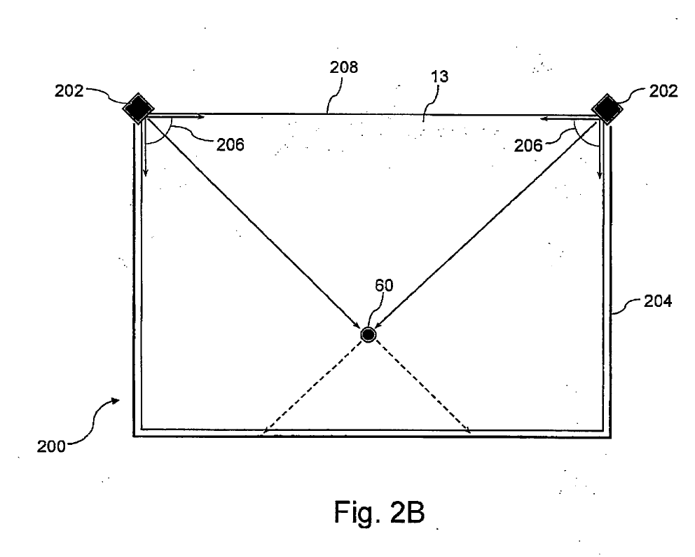

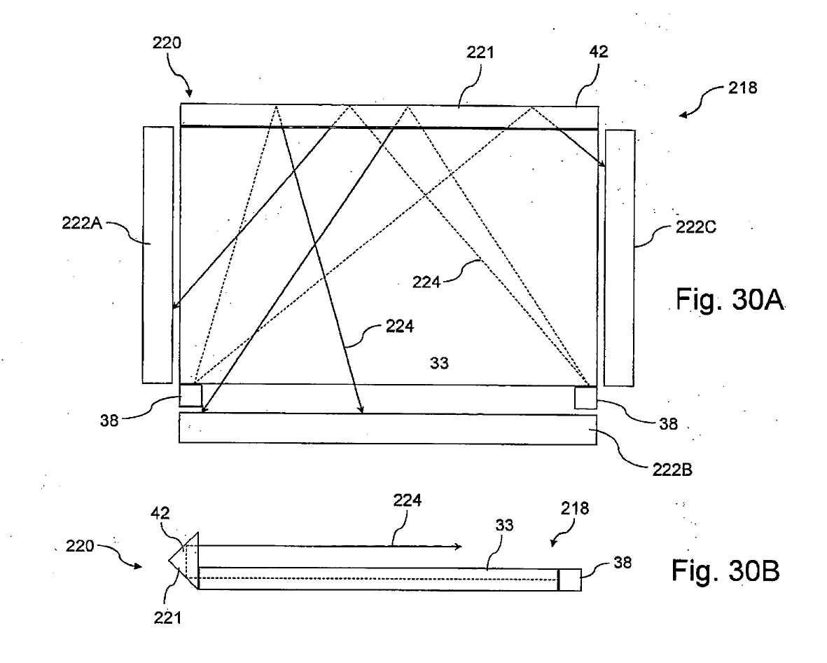

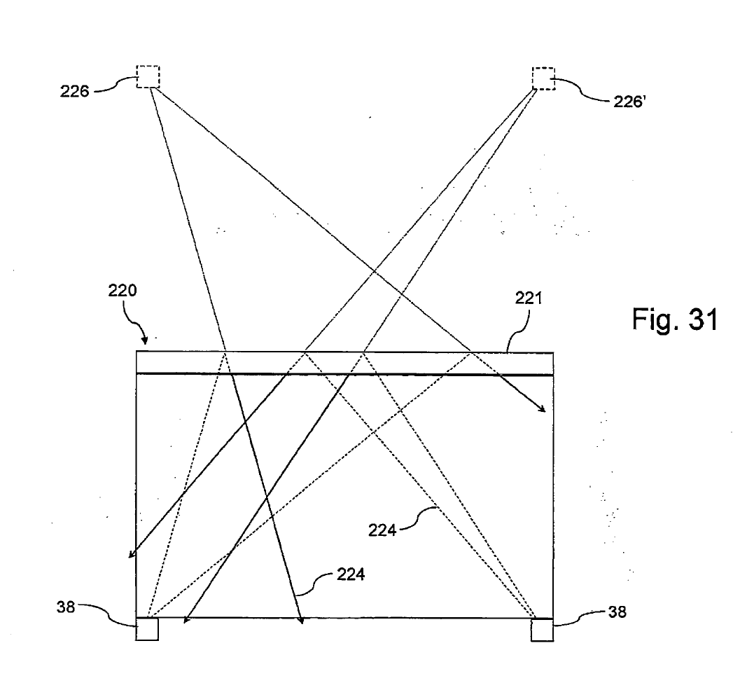

Turning now to the prior art ‘optical’ touch input device illustrated in plan view in FIG. 2B, we will show how application of optical guidance and redirection principles utilised in earlier embodiments of the present invention can be used to avoid the known spatial resolution problem in the vicinity of the edge 208. FIG. 30A shows in plan view a touch input device 218 including a transmissive body 220 comprising a transmissive element 33 and a redirection element 42 in the form of a turning prism 221 along one edge of the transmissive element, light detection means 222A, 222B and 222C along the other three edges, and a pair of optical sources 38 (e.g. infrared LEDs) directing light into the transmissive element with sufficient divergence to illuminate the entire length of the redirection element. Note that the light detection means 222B is displaced from the edge of the transmissive element to show the optical sources. The optical sources are spaced apart along the edge of the transmissive element opposing the turning prism, and are preferably located in or proximate to the corners as shown. A side view of the transmissive body 220 and one of the optical sources 38 is shown in FIG. 30B, and it will be seen that the transmissive body 220 of this embodiment differs from the transmissive bodies 30 of the earlier embodiments in that it does not include a collimation element. Light from the optical sources is guided by the transmissive element to the turning prism 221, which redirects it across the front of the transmissive element in a plurality of directions towards appropriately angled elements of the light detection means. FIG. 30A shows a selection of light paths 224, dashed when inside the transmissive element and solid when in free space, and it will be appreciated that an object can be detected and located by the interruption of two free space light paths. As shown schematically in FIG. 31, the inclusion of the transmissive body 220 folds the optical paths 224 such that they appear to emanate from virtual optical sources located at the positions 226, 226′, thereby ensuring that no portion of the input area has relatively poor spatial resolution.

The transmissive body 220 as shown in FIGS. 30A and 30B is formed as a pair of bodies, with a transmissive body and a redirection element manufactured separately and joined for example with an optical adhesive or with double sided tape as shown in FIG. 8. In alternative embodiments the transmissive body is unitary in form, produced for example by injection moulding of a plastics material.

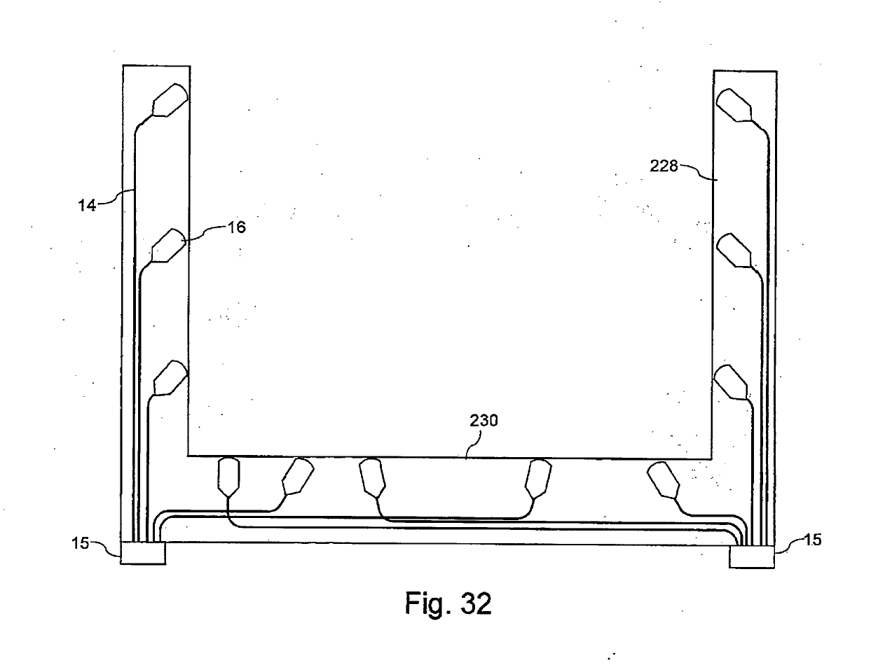

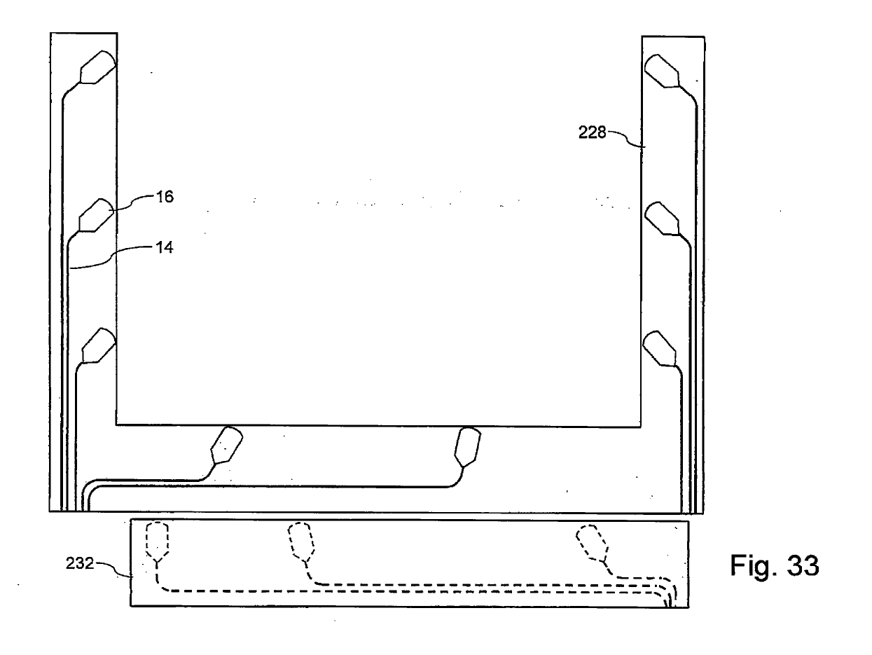

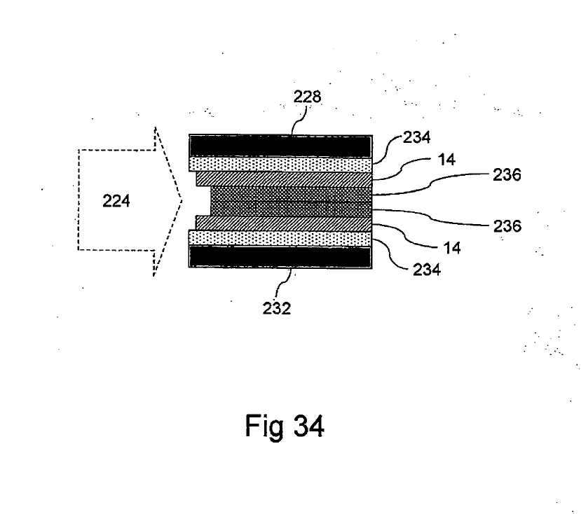

In preferred embodiments the light detection means 222A, 222B and 222C includes appropriately angled arrays of waveguides 14 and in-plane focussing lenses 16, fabricated for example on a single U-shaped substrate 228 as shown in FIG. 32, that guide the received signal light to two position-sensitive detectors 15. Alternatively receive waveguides could be fabricated on three separate substrates along each detection side of the input area. Note that for simplicity only a few receive waveguides per side are shown in FIG. 32. It will be seen from FIG. 32 that when the waveguides along the edge 230 are fabricated on a single substrate, the layout entails waveguide and/or lens crossings. For ease of fabrication and to avoid any possibility of optical cross-talk, it may be preferable to fabricate some of these waveguides on a separate substrate 232 as shown schematically in FIG. 33 (offset for clarity), and stack them as shown in side view in FIG. 34. Other waveguide layouts will occur to those skilled in the art. For mechanical robustness the stacking is preferably ‘waveguide to waveguide’, with optical isolation for the cores 14 provided by lower cladding layers 234 and upper cladding layers 236. Provided the signal beams 224 are sufficiently broad in the out-of-plane direction, both waveguide layers will receive an adequate amount of light; this is not difficult to ensure given that the core and cladding layers are each of the order of only 10 to 30 μm thick.

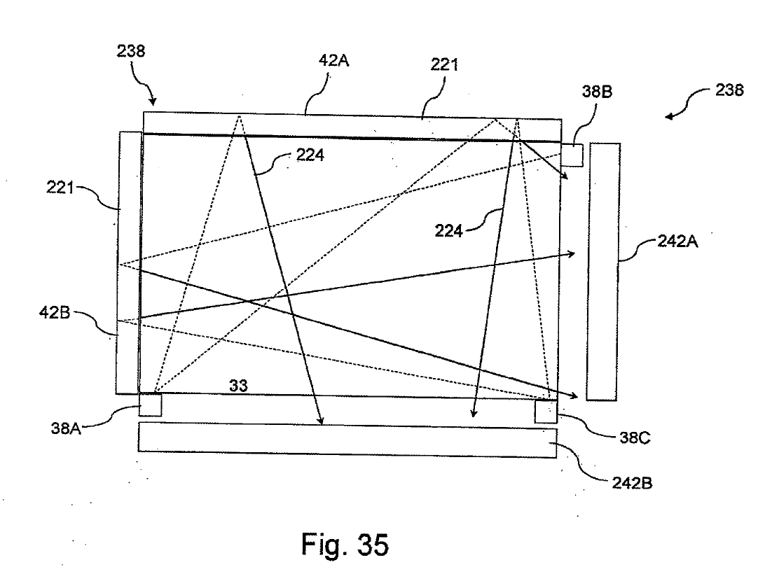

FIG. 35 shows in plan view an alternative touch input device 238 that operates along similar principles, this time including a transmissive body 240 comprising a transmissive element 33 and two redirection elements 42A and 42B in the form of turning prisms 221 along two adjacent edges of the transmissive element, light detection means 242A and 242B along the other two edges of the transmissive element, and optical sources 38A, 38B and 38C (e.g. infrared LEDs) located in or proximate to three corners of the transmissive element and directing light therein. Light from optical source 38A is guided by the transmissive element towards redirection element 42A, then propagates across the input area towards the elements (e.g. optical waveguides) of both light detection means, and likewise light from optical source 38B is directed towards the light detection means by redirection element 42B, and light from optical source 38C is directed towards the light detection means by redirection elements 42A and 42B.

Although the invention has been described with reference to specific embodiments, it will be appreciated by those skilled in the art that the invention may be embodied in many other forms.

1-110. (canceled)

111. A transmissive body comprising:
(a) a transmissive element adapted to receive, confine and transmit an optical signal in substantially planar form;
(b) a collimation element adapted to substantially collimate an optical signal; and
(c) a redirection element adapted to redirect an optical signal,
wherein said elements are arranged to receive an optical signal from an optical source and transmit, collimate and redirect said optical signal to produce a substantially collimated signal in a substantially planar form,
wherein said collimation element is a segmented reflector, a segmented lens or a diffractive grating.

112. A transmissive body according to claim 1 wherein said segmented lens is a Fresnel lens.

113. A transmissive body according to claim 1 wherein said transmissive body is formed as either:
(a) a unitary body comprising all three of said collimation, redirection and transmissive elements,
(b) a pair of bodies wherein one of said bodies comprises any two of said collimation, redirection and transmissive elements and the other of said bodies comprises the remaining element, or
(c) a triad of bodies, each said body comprising one of said collimation, redirection and transmissive elements.

114. A transmissive body according to claim 1, wherein said redirection element comprises one or more metallised plane reflectors.

115. A transmissive body according to claim 4, wherein said transmissive element is planar and said redirection element comprises a pair of metallised plane reflectors oriented at 45° to the plane of said transmissive element such that the substantially collimated, substantially planar signal propagates substantially parallel to said transmissive element.

116. A transmissive body according to claim 1, wherein said collimation element is positioned between said transmissive element and said redirection element.

117. A transmissive body according to claim 1, wherein said redirection element is positioned between said transmissive element and said collimation element.

118. A transmissive body according to claim 1, wherein said optical source, transmissive element, collimation element and redirection element are configured such that said substantially collimated, substantially planar optical signal propagates proximate to and substantially parallel to said transmissive element.

119. A transmissive body according to claim 8, when used as a component of a touch screen.

120. A transmissive body comprising:
(a) a collimation element adapted to substantially collimate an optical signal; and
(b) a redirection element adapted to redirect an optical signal,
wherein said elements are arranged to receive a substantially planar optical signal and collimate and redirect said optical signal to produce a substantially collimated signal,
wherein said collimation element is a segmented reflector, a segmented lens or a diffractive grating.

121. A transmissive body according to claim 10 wherein said segmented lens is a Fresnel lens.

122. A transmissive body according to claim 10 wherein said transmissive body is formed as a unitary body.

123. A transmissive body according to claim 10, wherein said redirection element comprises one or more metallised plane reflectors.

124. A transmissive body according to claim 10, when used as a component of a touch screen.

125. A method for producing an optical signal in substantially collimated planar form, said method comprising the steps of:
providing an optical signal from an optical source;
receiving, confining and transmitting said optical signal in planar form;
substantially collimating said optical signal with a segmented reflector, a segmented lens or a diffractive grating; and
redirecting said optical signal.

126. A method according to claim 15, wherein said optical signal is substantially collimated with a Fresnel lens.

127. A method according to claim 15, wherein said optical signal is received, confined and transmitted in planar form in a planar transmissive element.

128. A method according to claim 17, wherein said substantially collimated planar signal propagates in a plane substantially parallel to said transmissive element.

129. A method according to claim 18, wherein said substantially collimated planar signal propagates proximate to said transmissive element.

130. A method according to claim 19, wherein said substantially collimated planar signal is used to detect touch input to a touch screen.
